(19) United States
(12) Patent Application Publication
(10) Pub. No.: US 2026/0230468 A1
(43) Pub. Date: Aug. 6, 2026

(54) EMAIL-BASED AUTHENTICATION FOR ACCOUNT LOGIN, ACCOUNT CREATION AND SECURITY FOR PASSWORDLESS TRANSACTIONS

(71) Applicant: SWOOP IP HOLDINGS LLC, Wilmington, DE (US)

(72) Inventors: John P. Killoran, Jr., Albuquerque, NM (US); Patrick KILLORAN, Jackson Heights, NY (US); Isaiah BACA, Albuquerque, NM (US)

(73) Assignee: SWOOP IP HOLDINGS LLC, Wilmington, DE (US)

(21) Appl. No.: 19/043,188

(22) Filed: Jan. 31, 2025

(51) Int. Cl. H04L 9/40

(52) U.S. Cl. CPC H04L 63/083; G06Q 20/385; G06Q 20/4014; H04L 63/0428; H04L 63/0861; H04L 63/1425; H04L 9/3247; H04L 9/50; H04L 2463/082

(57) ABSTRACT

A system and method for secure, passwordless authentication using email-based authentication tokens. The system enables users to authenticate account access, complete transactions, and perform secure operations without relying on traditional passwords. Authentication is facilitated through the generation of an authentication request message containing a secure token, which is transmitted to a user's registered email address. The user responds by sending a return email containing the authentication token, which is then validated using artificial intelligence-based anomaly detection, digital fingerprinting, and biometric verification techniques. The system further enhances security through multi-device authentication, integrating Quick Response (QR) codes, SMS-based verification, and adaptive security mechanisms based on real-time risk analysis. The invention reduces reliance on password-based security models, minimizes exposure to credential-based attacks, and enhances user experience while providing a scalable, vendor-integrated authentication solution for e-commerce, financial transactions, and secure account management.

### FIELD OF INVENTION

The present invention is related to improvements in security systems that may be utilized in various applications such as electronic commerce, secure document access, and electronic authentication. The systems and methods include methods for accessing secure accounts without the use of passwords in order to eliminate the need for passwords. In addition, systems and methods further deter automated attacks online using email authentication.

### BACKGROUND

A customer wishing to conduct secure transactions is required to maintain a user identity through their electronic device. It is increasingly common for a customer to be required to maintain multiple devices, and therefore, their user identity is defined among a limited constellation of devices. The interplay between these devices offers opportunities for increased security and convenience.

Online vendors are required to provide their customers with password-secured accounts. These accounts depend upon the vendor to manage, store, and secure customer information. The storage of customer passwords and the constant management of password resets become a costly necessity for vendors. The existence of these password vaults exposes the vendor to undue security threats. Thus far there are no practical alternatives to this process. In addition, standard web-based checkouts and logins require the customer to remember a password each time they wish to check out or log in to an account. This is a source of major frustration and deters repeat purchases.

Email-based e-commerce has depended on human comprehension to respond to written customer requests and inquiries made via email messages. The time and effort required for interpreting and responding to customer messages make the scaling of such a service cumbersome and unfeasible for vendors who might wish to offer this service.

A need exists for a system and method that enables vendors to provide secure access to private information and secure sensitive transactions by utilizing the secure environment of email authentication to increase security and streamline what is now a complex process for vendors and customers. The system and method may provide a customer with a web-based checkout or login feature while finalizing the checkout and login process through email authentication to streamline the process for the customer. The system and method may allow vendors the convenience of websites and shopping carts, while pairing the convenience of email, SMS, and social media based login.

Artificial Intelligence (AI) and Machine Learning (ML) are interconnected fields of computer science focused on creating systems that can perform tasks typically requiring human intelligence. AI is the broader concept, encompassing systems designed to reason, solve problems, learn, perceive, understand language, and make decisions. It can be categorized into narrow AI, which is task-specific (e.g., recommendation systems or voice assistants like Siri), and general AI, which refers to hypothetical systems capable of performing any intellectual task a human can. Machine Learning, on the other hand, is a subset of AI that enables machines to learn from data rather than being explicitly programmed for specific tasks. It involves using algorithms to analyze data, identify patterns, and improve performance over time without constant human input. ML is divided into supervised learning, which uses labeled data for predictions; unsupervised learning, which uncovers patterns in unlabeled data; and reinforcement learning, where systems learn through trial and error by interacting with an environment. While AI aims to create intelligent systems, ML provides the tools and methods to achieve this by enabling systems to adapt and learn from data, powering applications like natural language processing, computer vision, and autonomous systems.

AI/ML implementation involves several key stages, combining data preparation, algorithm selection, model training, and deployment to create systems that can analyze information and make predictions or decisions. The process begins with problem definition, where the objective of the AI/ML system is identified, such as fraud detection, image recognition, or personalized recommendations. After defining the goal, the next step is data collection and preprocessing, where relevant data is gathered, cleaned, and formatted to ensure quality and consistency. This stage may also involve feature engineering, which selects and transforms data attributes to improve model performance.

Once the data is prepared, an appropriate algorithm is selected based on the problem type, such as supervised learning for classification, unsupervised learning for clustering, or reinforcement learning for decision-making tasks. The model is then trained on the data, meaning the algorithm learns patterns and relationships from the input. During training, techniques like cross-validation and hyperparameter tuning are used to optimize performance. The model's effectiveness is evaluated using a separate dataset to measure metrics such as accuracy, precision, recall, or other relevant benchmarks.

After achieving a satisfactory model, the next step is deployment, where the trained model is integrated into a system or application. This may involve creating APIs, embedding the model into software, or deploying it in cloud environments for scalability. Post-deployment, monitoring and maintenance are crucial to ensure the model continues to perform well in real-world conditions. Retraining the model with new data, handling drift in data patterns, and updating algorithms are essential for long-term success. AI/ML implementation is an iterative process that requires domain expertise, robust infrastructure, and ongoing refinement to meet evolving needs effectively.

### SUMMARY

Vendors who choose not to offer a conventional password-based login but instead offer their customers an email-based login option find the formatting of emails with email addresses time burdensome and hobbled by customer error. In this environment, the security of the email account is especially important. Disclosed is a system and method that allows for a seamless and automated process that utilizes Quick Response codes and multiple devices to generate emails that facilitate secure transactions such as payments, login and registration. The system and method provides a distinct user experience based on user device format. Disclosed is a system and method that leverages customer use of multiple devices for increased security and convenience.

A system and method that monitors the customer email authentication and analyzes device data is disclosed. The system and method allows the vendor to identify suspect behavior by coordinating various forms of machine learning, artificial intelligence analysis, digital finger printing and biometric confirmation to secure customer authentication and validation of the customer account and transactions.

Email-based e-commerce has depended on human comprehension to read and interpret customer requests and to respond to those requests in an appropriate manner. A system and method that allows customers to send emails that enable secure transactions between a customer, vendor and authentication system that include written instructions from the customer and are analyzed and interpreted via machine learning is disclosed. The system and method allows for changes to be transacted in a customer's secure account without the customer's direct access but instead by the mobilizing of artificial intelligence to implement the change on the customer's behalf.

Vendors wishing to supply customers with secure account login and transactions are burdened with the task of maintaining user identifications (IDs) and passwords for every customer account. A system and method is disclosed for providing vendors an alternative to a password-based security system. The system and method also allow vendors to manage secure transactions by leveraging various message authentication techniques while allowing the vendor full control over related processes such as secure login, payment processing and fulfillment. The system and method also monitor message requests using AI/machine learning, biometric, passkey and digital fingerprinting. The system and method monitor message request for secure transactions from customers for the vendor to guarantee that the communication has not been compromised. Consolidating the authentication of users to their messaging minimizes the need for each individual vendor to maintain their own password for access to a customer account. This eliminates the requirement that customers generate a password thus increasing convenience and decreasing security risks associated with the use of passwords. This decreases risk not only for customers and vendors but also decreases the risk exposure across the internet-as the system scales.

### BRIEF DESCRIPTION OF THE DRAWINGS

A more detailed understanding can be had from the following description, given by way of example in conjunction with the accompanying drawings wherein:

FIG. 1 illustrates a system diagram of an email based Authentication Network that facilitates email-based authentication for sign in and security;

FIG. 2 illustrates an example email message that solicits the purchase of goods from a vendor;

FIG. 3 illustrates an email message for placing an order;

FIG. 4 illustrates an advertisement email message that solicits a donation;

FIG. 5 illustrates an email message for ordering a donation;

FIG. 6 is flow diagram of an authentication system 140 authenticating received emails from registered and non-registered customers;

FIG. 7 illustrates a method 600 providing a dynamic display of options for secure transactions;

FIG. 8 is a diagram illustrating the flow of transactions between the authentication system 140, the vendor 120 and the customer device 150 for granting secure transactions without a password using WebSockets with email-based authentication and a short URL without a password;

FIG. 9 is an example screen 900 used to request secure account login via the vendor website;

FIG. 10 is an example email message 1000 used for authentication of the transaction;

FIG. 11 is an example of a secure account page 1100;

FIG. 12A is a diagram illustrating method 1200 describes the flow of transactions between the authentication system 140, the vendor 120 and customer device 1 150 using a quick response code to initiate an email for granting a secure transaction without a password;

FIG. 12B is an example of a Quick Response code that may be used 1200B;

FIG. 13 is a diagram illustrating method 1300 for secure transactions utilizing multiple customer devices for increased security;

FIG. 14 is a diagram illustrating method 1400 for granting secure transactions using multiple devices without a password;

FIG. 15 is an example of a webpage displaying the QR code;

FIG. 16 a diagram illustrating the flow of in-store transactions between the authentication system 140, the vendor 120 and customer device 150 for granting a secure transactions using email with websockets without a password;

FIG. 17 is a mobile cashier device for generating an invoice and access the authentication system;

FIG. 18 is an example of the email message request for a secure transaction method 1800;

FIG. 19 is an example of the display of the invoice in the illustration 1900 of a customer device having accessed a secure channel;

FIG. 20 is a transactional flow diagram 2000 illustrating the process of a customer updating a secure account without the use of a password using artificial intelligence/Machine Learning;

FIG. 21 is an example of an email response message;

FIG. 22A is a flow diagram 2200 A illustrating the authentication system 140 analyzing email messages with artificial intelligence/machine learning to facilitate a secure transaction on the behalf of the customer;

FIG. 22B is a flow diagram 2200 B illustrating the authentication system 140 analyzing a variety of messages with artificial intelligence/Machine learning and response and authenticating transactions using email;

FIG. 23 is a flow diagram 2300 illustrating the authentication system utilizing an artificial intelligence machine learning data monitoring process for improved security;

FIG. 24 is a flow diagram 2400 illustrating the authentication system monitoring device data and email messages for improved security;

FIG. 25 is a diagram illustrating the flow 2500 of transactions between the authentication system 140, the vendor 120 and the customer device 1 150 for granting a secure login using email without a password utilizing biometric credentials;

FIG. 26 is a flow diagram 2600 illustrating flow of transactions within the authentication system 140, for granting a secure transactions using authentication via FIDO 2 standard and email without a password;

FIG. 27 is an illustration of a method 2700 depicting an authentication system 140 requesting, generating and granting access to an email account without a password;

FIG. 28 is a diagram illustrating the flow 2800 of transactions between the authentication system 140, the email service provider 170 and the customer device 1 150 for granting a secure login to an email account without a password utilizing biometric confirmation;

FIG. 29 is a diagram illustrating the flow 2900 of transactions between the authentication system 140, the email service provider 170 and the customer device 1 150 for granting a secure login to an email account without a password utilizing SMS messaging.

### DETAILED DESCRIPTION

The present invention introduces a transformative approach to enhancing security, efficiency, and user convenience in managing secure accounts and transactions. Existing systems for secure access and e-commerce transactions heavily rely on passwords, which often create significant challenges for both users and vendors. Customers are burdened with remembering numerous passwords, while vendors face the logistical and financial strain of managing password databases, password resets, and security breaches. Embodiments of the invention eliminate the need for passwords by leveraging advanced email-based authentication systems combined with machine learning (ML), artificial intelligence (AI), and blockchain technology. By replacing conventional password systems with innovative methods such as Quick Response (QR) codes, digital fingerprinting, and biometric authentication, embodiments of the invention ensure robust security while streamlining user experience. The disclosed system recognizes and addresses the limitations of traditional password-based authentication by offering a seamless, scalable solution that integrates multiple devices and communication protocols. Embodiments of the invention enable vendors to offer secure account access and transaction processing through a combination of email, SMS, and social media-based authentication mechanisms. Embodiments utilize AI/ML to analyze user behavior, detect anomalies, and prevent fraudulent activities. Biometric and digital fingerprint verification further enhance security by ensuring that only authorized users gain access to sensitive data and systems. Blockchain technology is employed by some embodiments to create a decentralized and immutable record of transactions, bolstering trust, transparency, and data integrity.

This invention introduces a dynamic, multi-device authentication system that adapts to diverse user needs and device capabilities. Embodiments of the invention employ real-time communication protocols like WebSockets and incorporate AI-driven analysis, to ensure low-latency, high-security interactions between users and vendors. Additionally, it provides flexible options for secure transactions, including payment processing, account updates, and access to secure servers.

In the context of the invention, a “transaction” refers to a secure exchange or action facilitated by the authentication system, involving customer, vendor, or third-party interactions. This may include, but is not limited to, secure access to an account, processing payments, updating account details, making reservations, completing e-commerce activities or Access secure server. Transactions are verified and authenticated through mechanisms like email-based authentication, tokens, QR codes, AI/ML analysis, digital signatures, and additional security protocols (e.g., SPF/DKIM). These transactions are designed to enhance security, streamline processes, and eliminate reliance on traditional password-based systems.

In the context of the invention, a “vendor” refers to an entity or individual offering goods, services, or access to resources that require secure user authentication and transaction processing. Vendors can include online retailers, financial institutions, service providers, subscription platforms, or any organization that manages user accounts, processes payments, or facilitates secure interactions through digital platforms. Vendors are integral to the system, as they implement the authentication and transaction solutions described in the invention to enhance security, streamline user access, and protect sensitive data. By adopting the disclosed methods, vendors reduce the reliance on traditional password-based systems, improve user experience, and mitigate risks associated with fraud, data breaches, and unauthorized access. This can include a broad range of applications, such as e-commerce platforms, banking apps, content delivery services, or secure file-sharing systems.

In the context of the invention, a “customer” refers to an end-user or client who interacts with the vendor's system to access goods, services, or resources. They initiate requests for access, transactions, or services and rely on the system to authenticate their identity, ensure data privacy, and facilitate secure communication with the vendor. The invention enhances the customer's experience by providing secure, efficient, and user-friendly authentication methods, reducing reliance on traditional credentials such as passwords. For customers, this improves convenience and trust in the vendor's platform while safeguarding their sensitive information from threats such as unauthorized access, phishing attacks, or identity theft. Customers can range from individuals using personal accounts to business entities accessing vendor services on a corporate level.

In the context of the invention, a “token” is a secure, digital representation of authentication credentials or information that enables secure communication between a customer and a vendor. Tokens are typically generated by an authentication server or security system after successfully verifying a customer's identity. They serve as temporary, unique identifiers that authorize specific actions or access to resources within the vendor's system. Tokens are integral to the invention's security framework, as they replace traditional, static credentials like passwords with dynamically issued, time-bound, and context-aware credentials. This minimizes the risk of credential theft or misuse. Depending on the implementation, tokens may be structured as JSON Web Tokens (JWTs), encrypted session identifiers, or other cryptographic constructs that include information such as user identity, permissions, and expiration details. The use of tokens allows the invention to achieve secure, scalable, and efficient authentication and authorization processes, reducing vulnerabilities while ensuring that both customers and vendors can interact in a trusted environment.

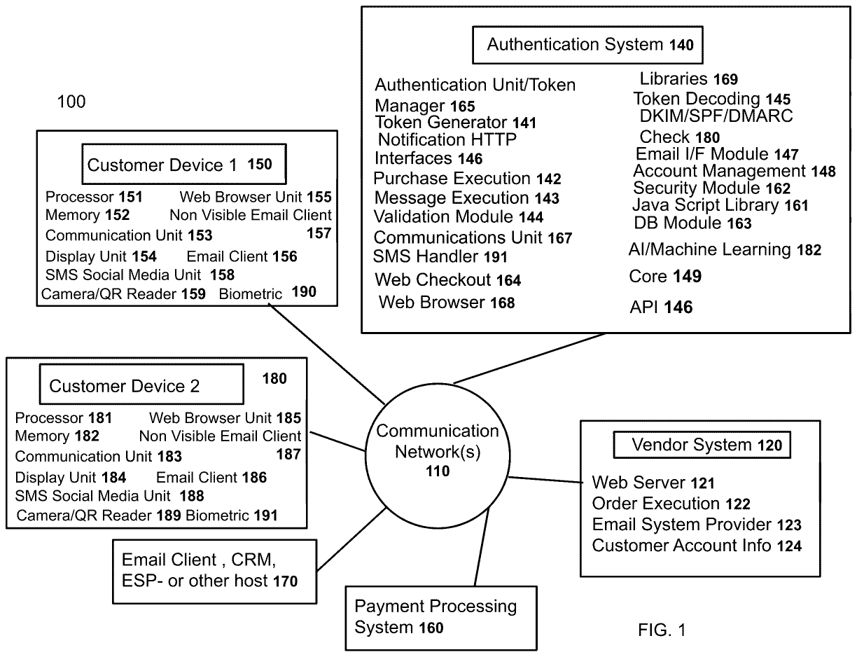

As shown in FIG. 1, the disclosed methods provide different benefits based on the dynamic nature of the e-commerce system. The Authentication Network offers vendors multiple methods to validate a message based on authenticating identifiers and tokens and the categorization of these emails into registered and unregistered customers.

The embodiments described below may also be integrated with an email service provider, customer relationship management, or directly with a payment processor. Payment processing may occur in any number of ways using multiple gateways, banks, credit cards, debit cards, gift cards, direct carrier billing, automatic clearinghouses, or virtual currency. Although the description below focuses on the use of email, Short Message Service (SMS) and social media networks may also be used. Although some examples and discussion herein generally use SMS, other texting formats may be substituted for SMS, including Extensible Markup Language (XMPP), Session Initiation Protocol (SIP), Voice over Internet Protocol (VoIP), multimedia messaging service (MMS), Messaging Queuing Telemetry Transport (MQTT), and Apple Push Notification Service (APNS) used in services such as Whatsapp, Viber, Facebook Messenger, iMessage, and other forms Internet Telephony Protocols. The configuration of the system may vary accordingly.

An Authentication Network 100 that facilitates transactions between a customer device 150 and a vendor 120 utilizing an authentication system, 140 is disclosed. A method and apparatus allow the Authentication system 140, such as an Email Payment Gateway, to enable customers to log in to secure accounts via a series of messages authenticated in different media. The example Authentication Network 100 shown in FIG. 1 may be used for e-commerce transactions, secure document exchange, or restricting access to files or web pages. The example Security Network 100 includes a vendor system 120, an authentication system 140, a customer device 150, a banking server (not shown), an email service provider 170, and a payment processing system 160 160 that may communicate over one or more wired and/or wireless communication network 110. The wired or wireless communication network 110 may be public, private, or a combination of public or private networks.

The customer device 150 may refer to any electronic device operated by a customer to interact with the authentication system 140 and conduct secure transactions. This device may include, but is not limited to, smartphones, tablets, desktop computers, laptops, or other internet-connected devices. The customer device 150 may serve as the primary interface for accessing vendor services, submitting authentication requests, and verifying identity through email-based authentication, biometric verification, or other security mechanisms.

The customer device 150 may include multiple components that facilitate secure interactions, such as a browser unit 155, which allows customers to access vendor websites, authentication portals, or checkout pages. It may also include an email client 156, which enables the customer to send and receive authentication messages required for login, payment processing, or other secure actions. Additionally, the device may integrate a biometric unit 190, capable of capturing and processing biometric data such as fingerprints, facial recognition, or voice authentication to enhance security. A camera unit 159 or NFC (Near Field Communication) module may be used for scanning QR codes or engaging in contactless authentication processes.

Furthermore, the customer device 150 may participate in multi-device authentication scenarios, where a customer utilizes more than one device—such as a smartphone and a desktop computer—to complete a secure transaction. In such cases, the authentication system 140 may validate interactions between multiple devices controlled by the same user to confirm identity and prevent fraudulent activity. The customer device 150 may also generate, send, or receive tokens that facilitate secure email-based authentication, allowing access to accounts, payments, or other protected services without requiring traditional passwords.

The customer device 2 (180) may refer to a secondary electronic device operated by a customer, which can be used in conjunction with or independently from the primary customer device 1 (150) to facilitate secure transactions, authentication, or account access. This device may include smartphones, tablets, laptops, desktop computers, smartwatches, or other internet-enabled devices.

Customer device 2 (180) may be utilized in multi-device authentication scenarios where a customer interacts with both devices to enhance security. For example, a transaction initiated on customer device 1 (150), such as logging into a vendor website or making a payment, may require confirmation via customer device 2 (180). This may be achieved through various mechanisms, such as scanning a QR code displayed on one device with the camera unit of another, receiving an authentication email on customer device 2 (180), or verifying biometric credentials on the second device.

Additionally, customer device 2 (180) may operate independently for authentication purposes, such as accessing email-based authentication messages, confirming secure login requests, or providing multi-factor authentication inputs. It may also be integrated into systems where artificial intelligence and machine learning analyze behavioral patterns across multiple devices to detect anomalies and prevent fraud. By leveraging multiple customer devices, the system may improve security, streamline authentication, and offer enhanced user convenience while maintaining robust fraud detection measures.

In the context of the current application, digital fingerprinting refers to a technique used by the authentication system 140 to uniquely identify and verify a customer device (150, 180) based on a combination of hardware, software, and network attributes. This process may enhance security by ensuring that authentication and transaction requests originate from recognized and trusted devices, thereby mitigating fraud and unauthorized access.

Digital fingerprinting may involve collecting various data points from the customer device, including but not limited to operating system details, browser version, installed plugins, screen resolution, time zone, IP address, MAC address, battery level, geographic location, and device-specific identifiers. These attributes may be analyzed and stored as a unique device signature, which can be referenced during future authentication attempts. The authentication system may compare incoming requests against previously recorded digital fingerprints to determine whether the request is originating from an expected and authorized device.

Additionally, digital fingerprinting may be used in conjunction with AI/Machine Learning 182 to detect anomalies or inconsistencies in device behavior. If a customer typically accesses their account from a specific device and location but suddenly attempts authentication from a significantly different configuration, the system may flag the request as suspicious. This could trigger additional security measures, such as requiring biometric verification, multi-factor authentication, or manual user confirmation before granting access.

By leveraging digital fingerprinting, the authentication system may enhance security without relying solely on passwords. This approach may improve fraud detection, prevent account takeovers, and streamline secure transactions by dynamically adapting to legitimate user behaviors while identifying potential threats.

Alternatively or additionally, the web browser unit 155 may implement Rich Internet Application (RIA) and/or multimedia technologies such as ADOBE FLASH and/or other technologies compatible with Internet-based communications. The web browser unit 155 may implement RIA and/or multimedia technologies using one or web browser plug-in modules (e.g., ADOBE FLASH) and/or using one or more sub-modules within the web browser unit 155 itself. The web browser unit 155 may display data on one or more display devices (not depicted) that are included in, or connected to, the customer device 150, such as a liquid crystal display (LCD) display or monitor. The customer device 150 may receive an input from a user from an input device (not depicted) that is included in, or connected to, the customer device 150, such as a keyboard, a mouse, a microphone, or a touch screen, and provide data that indicates the input to the web browser unit 155.

The vendor system 120 may include a web server 121, order execution unit 122, an email system provider 123, and customer account info 124. The vendor system may be substituted for a financial management system, as illustrated in the examples described herein.

The web server 121 provides a website that may be accessed by a customer device 150. The web server 121 may implement HTTP protocol and may communicate Hypertext Markup Language (HTML) pages and related data from the website to/from the customer device 150 using HTTP. The vendor server 120 may be connected to one or more private or public networks (such as the Internet), via which the web server 121 communicates with devices such as the customer device 150. The web server 121 may generate one or more web pages, may communicate the web pages to the customer device 150, and may receive responsive information from the customer device 150.

The web server 121 may be, for example, an NGINX server, an APACHE HTTP server, a SUN-ONE Web Server, a MICROSOFT INTERNET Information Services (IIS) server, and/or may be based on any other appropriate HTTP server technology. The vendor server 120 may also include one or more additional components or modules (not depicted), such as one or more load balancers, firewall devices, routers, switches, and devices that handle power backup and data redundancy.

The vendor system 120 may also include one or more additional components or modules (not depicted), such as one or more load balancers, firewall devices, routers, switches, and devices that handle power backup and data redundancy.

The order execution unit 122 is configured to receive instructions included in received messages and executes orders on behalf of the vendor system 130.

The memory may be configured to store information associated with e-commerce transactions. This may include inventory information, information used to generate web pages, customer information, and other e-commerce data.

The Authentication system 140 may include a token generator 141, a purchase execution module 142, a message execution module 143, a validation module 144, a database module 163, a token decoder 145, an API unit 146, an email interface module 147, an account management unit 148, core unit 149, web checkout 164, JAVA script library 161, a security module 162, authentication unit/token manager 165, manager unit 166, communications unit 167, web browser 168, libraries 169, a Universal Resource Locator (URL) translator 181, and a manager unit 166. While only one vendor system 120 is shown communicating with the Authentication system 140, this is shown as an example only. The Authentication system 140 may communicate with an internal or external email service provider (ESP) 170 and an internal or external payment processing system 160. The Authentication system 140 may communicate with multiple vendor systems 120.

Similarly, vendors may register with the Authentication system 140. The Authentication system 140 may provide the vendor system 120 with a public key and private key to be used in the token transaction in accordance with the methods described herein. When a transaction is attempted (e.g., for invoices and payments), the Authentication system 140 decodes the token, authenticates the sender of the email, which may allow the transaction to be processed. While the Authentication system 140 is depicted as a separate entity in FIG. 1, this is shown as an example only. The Authentication system 140 may be controlled and/or co-located with the vendor system 130 and/or the email service provider 170.

The token generator 141 may generate tokens for use in e-commerce transactions. Tokens may be encrypted or plain text strings that contain information to perform a transaction when sent to the Authentication system 140. A token may be one or multiple encrypted strings, files, passwords, ciphers, plain text, or other data which may contain information used to perform or authenticate a transaction. While FIG. 1 shows the token generator 141 as being a part of the Authentication system 140, it may be hosted by any trusted party with access to the private key. For example, the banking server may include a token generator 141. A token may include one or more of the following parameters or other parameters not listed below:
Private-key: The private key provided by the Authentication system 140.
Public-key: E-commerce system's 140 public key, provided by the Authentication system 140.
Auth-key: Any additional data that may be used to authenticate the transaction, including, but not limited to, biometric identification, location data, and other fraud detection systems.
Partner-id: The partner ID given provided by the Authentication system 140.
Environment: The environment the vendor wants to generate buttons for. This distinguishes whether the token is being used in a testing environment or in the live environment (and running real transactions).
Type: The type of token to generate (e.g., bulk, email-targeted, etc.). There are multiple types of tokens that a token generator 141 may generate and decode. For example, site tokens may be used for website transactions, email tokens for minimum-of-clicks email payments, and universal tokens for email validations.
Card: The card token associated with the recipient of this token. When a customer is registered with the Authentication system 140, the vendor receives a credit card token—a unique identifier that references the specific card associated with that customer and vendor. When the vendor is generating a token to submit to Authentication system 140, they may include the card token as a customer identifier.
Email: The email associated with the receipt of this token. In some instances, more than one email address may be included in the token. This allows for more than one email address to be associated with a customer. For example, a customer may link both their personal and work email addresses. In this manner, if the response email is sent from either their personal or work email addresses the token will be able to properly authenticate the user.
URL: The Signup URL, the recipient, may go to if the customer doesn't have payment information registered with Authentication system 140.
Amount: The amount a customer should be charged for the transaction the token is generated for.
User-data: Data to pass back as a reference. This data may include custom data that the vendor may want to pass through the Authentication system 140 and receive back when a transaction has been completed. It may include an item reference number or SKU, customer address, or other pieces of data that are not required by Authentication system 140 to complete a transaction but that the vendor wants to be associated with that transaction.
Expires: Expiration date for a token and represents an integer value of seconds since epoch.
Header-user-agent: The HTTP_USER_AGENT from the request header. HTTP headers are sent as part of a request from a customer's web browser unit within customer device 150 for a piece of information. These headers define the parameters that the web browser unit is expecting to get back. The user-agent is the identifier of the software that is submitting the request—typically the identifier of the web browser unit that is requesting the content.
Header-accept-language: The HTTP_ACCEPT_LANGUAGE from the request header. The accept-language is the acceptable language for the response—e.g., the language in which the web browser unit is requesting the content be sent back.

Header-accept-charset: The HTTP_ACCEPT_CHARSET from the request header. The accept-charset is the character sets that are acceptable for the response—e.g., the character set in which the web browser unit is requesting the content be sent back.
IP address: The IP address of the token recipient.
Email Type: Whether the token is for use with mail to links, copy and paste or PIN authentications;
Device Type: Whether the email is sent from a mobile phone or a computer. In some instances, it may also indicate the operating system and other information about the hardware;
Device Specific Information: Information that is unique to the physical device. For example, the device specific information may include the current geolocation, the mac address, or current battery level. In some instances, the device specific information contains one or more parameters from the digital finger print of the customer device.
Email Client: An indication of what type of email client will send the email. For example, this token could indicate that the email will be sent from Microsoft Outlook or GMAIL.

In one example, a bulk token may omit the card and email fields, thereby allowing for the tokens to be shared. Additionally, or alternatively, a bulk token may include the card field and/or email field, but the Authentication system 140 may be configured to ignore those fields and/or other fields based on the type field.

The purchase execution module 142 facilitates the execution of payments between a customer and a vendor.

The message execution module 143 is configured to analyze received messages and communicate with the token decoder 145 to determine if the received message is valid and to identify the request embedded in the message (e.g., request for the purchase of goods.) If the token decoder 145 indicates the token is valid, the message execution module 143 may then access the account management unit 148 to verify a transaction.

The database module 163 serves as a database to store information that may be accessed by the Authentication system 140.

The token decoder 145 may be configured to decode tokens received from external sources, such as a vendor system 120 or a customer device 150.

The validation module 144 may serve to authenticate received emails using the DomainKeys Identified Mail (DKIM) and/or Sender Policy Framework (SPF) protocols. For example, SPF allows a domain owner to add a file or record on the server that the recipient server cross-checks. SPF is described in Internet Engineering Task Force (IETF) RFC 7208, which is herein incorporated by reference.

Similarly, DKIM may be used to embed information within the email. DKIM is described in Internet Engineering Task Force (IETF) RFC 6376, which is incorporated by reference as if fully set forth herein.

Likewise, Domain-based Message Authentication, Reporting, and Conformance (DMARC) is a mechanism by which a mail-originating organization can express domain-level policies and preferences for message validation. DMARC is described in Internet Engineering Task Force (IETF) RFC 7489, which is incorporated by reference as if fully set forth herein.

While these specific validation/authentication protocols are discussed herein, any known validation/authentication protocol may be used, and the use of the DKIM, SPF, and DMARC protocols are used only to enhance the understanding of the reader by using a specific possible validation/authentication protocol.

Generally, SPF is an email validation system designed to detect email spoofing by providing a mechanism to allow receiving mail exchangers to check that incoming mail from a domain is being sent from a host authorized by that domain's administrators. The list of authorized sending hosts for a domain may be published in the Domain Name System (DNS) records for that domain in the form of a specially formatted TXT record. Sender Policy Framework is described in IETF publication RFC 7208, which is incorporated by reference as if fully set forth.

The Simple Mail Transfer Protocol (SMTP) permits any computer to send an email claiming to be from any source address. SPF allows the owner of an Internet domain to specify which computers are authorized to send an email with sender addresses in that domain, using Domain Name System (DNS) records. Receivers verifying the SPF information in TXT records may reject messages from unauthorized sources before receiving the body of the message.

The sender address is transmitted at the beginning of the SMTP dialog. If the server rejects the sender, the unauthorized client should receive a rejection message, and if that client was a relaying message transfer agent (MTA), a bounce message to the original sending address might be generated. If the server accepts the sender and subsequently also accepts the recipients and the body of the message, it should insert a Return-Path field in the message header in order to save the sender address.

Generally, DKIM is an email validation system designed to detect email spoofing by providing a mechanism to allow receiving mail exchangers to check that incoming mail from a domain is authorized by that domain's administrators. A digital signature included with the message may be validated by the recipient using the signer's public key published in the DNS. DKIM is the result of merging DomainKeys and Identified Internet Mail. Prominent email service providers implementing DKIM include Yahoo, Gmail, AOL, and FastMail. Any mail from these organizations should carry a DKIM signature.

More specifically, both signing and verifying modules are usually part of a mail transfer agent (MTA). The signing organization may be a direct handler of the message, such as the author, the originating sending site, or an intermediary along the transit path, or an indirect handler such as an independent service that provides assistance to a direct handler. In most cases, the signing module acts on behalf of the author organization or the originating service provider by inserting a DKIM-Signature: header field. The verifying module typically acts on behalf of the receiver organization.

DKIM is independent of Simple Mail Transfer Protocol (SMTP) routing aspects in that it operates on the RFC 5322 message—the transported email's header and body—, not the SMTP envelope defined in RFC 5321. Hence, the DKIM signature survives basic relaying across multiple MTAs. DKIM allows the signer to distinguish its legitimate mail stream. This ability to distinguish legitimate mail from potentially forged mail has benefits for recipients of email as well as senders, and “DKIM awareness” is programmed into some email software.

The “DKIM-Signature” header field, by way of example, may include a list of “tag=value” parts. Tags are short, usually only one or two letters. The most relevant ones are b for the actual digital signature of the contents (headers and body) of the mail message, bh for the body hash, d for the signing domain, and s for the selector. The default parameters for the authentication mechanism are to use SHA-256 as the cryptographic hash and RSA as the public key encryption scheme, and encode the encrypted hash using Base64. The receiving SMTP server uses the domain name and the selector to perform a DNS lookup. For example, given the signature:
DKIM-Signature: v=1; a=rsa-sha256; d=example.net; s=brisbane;
c=relaxed/simple; q=dns/txt; l=1234; t=1117574938; x=1118006938;
h=from:to:subject:date:keywords:keywords;
h=MTIzNDU2Nzg5MDEyMzQ1Njc4OTAxMjM0NTY3ODkwMTI=;
b=dzdVyOfAKCdLXdJOc9G2q8LoXSIEniSbav+yuU4zGeeruD00IszZ VoG4ZHRNiYzR.

A verifier queries the TXT resource record type of brisbane._domainkey.example.net. The selector is a straightforward method to allow signers to add and remove keys whenever they wish—long lasting signatures for archival purposes are outside DKIM's scope. Some more tags are visible in the example:
v is the version,
a is the signing algorithm,
c is the canonicalization algorithm(s) for header and body,
q is the default query method,
l is the length of the canonicalized part of the body that has been signed,
t is the signature timestamp,
x is it's expire time, and
h is the list of signed header fields, repeated for fields that occur multiple times.

The DKIM-signature header field itself is always implicitly included in h.

The data returned from the verifier query is also a list of tag-value pairs. It includes the domain's public key, along with other key usage tokens and flags. The receiver may use this to then decrypt the hash value in the header field and, at the same time, recalculate the hash value for the mail message (headers and body) that was received. If the two values match, this cryptographically proves that the mail was signed by the indicated domain and has not been tampered with in transit.

Signature verification failure does not force rejection of the message. Instead, the precise reasons why the authenticity of the message may not be proven should be made available to downstream and upstream processes. Methods for doing so may include sending back a message or adding an Authentication-Results header field to the message as described in RFC 7001, which is incorporated as if fully set forth.

While DKIM, SPF, and DMARC protocols are discussed herein, validation module 144 may perform any authentication and validation type protocols. DKIM, SPF, and DMARC are used to provide examples of such validation protocols that may be performed in validation module 144.

The API unit 146 the API unit may facilitate communication and integration between the authentication system and external systems, including vendor platforms, email service providers, financial institutions, and customer devices. It may serve as an interface that allows external entities to interact with the authentication system 140 by exposing defined endpoints for secure transactions, authentication requests, and data exchanges.

The API unit 146 may support authentication and token management by enabling vendors to submit authentication requests, verify customer identities, and validate transactions. It may facilitate the generation, decoding, and validation of authentication tokens used in email-based transactions. Additionally, it may support secure transaction processing by allowing vendors to initiate and monitor email-based transactions, such as order confirmations, invoice payments, and donations, without requiring traditional passwords.

To enhance interoperability, the API unit 146 may integrate with third-party email service providers, banking systems, and digital wallets, streamlining authentication and payment workflows. It may also communicate with customer relationship management (CRM) systems, assisting vendors in tracking user authentication history and transaction status. Further, the API unit may facilitate dynamic data exchange and customization by enabling vendors to retrieve and update customer account details, transaction records, and security settings. Vendors may configure authentication settings, such as defining access controls, setting transaction limits, and implementing fraud detection mechanisms.

For real-time communication, the API unit 146 may employ protocols such as WebSockets or RESTful API calls to provide vendors and customers with instant updates on authentication requests, transaction approvals, and security alerts. Vendors may receive immediate feedback on transaction status, including email verification results, fraud detection signals, and risk assessments. The API unit may be implemented using secure protocols such as HTTPS, OAuth, and JSON Web Tokens (JWT) to ensure encrypted communication and access control. Additionally, it may support multi-factor authentication (MFA) mechanisms to ensure that only authorized entities interact with the authentication system 140.

By providing a structured and secure interface for external communication, the API unit 146 may enhance the flexibility, scalability, and security of the authentication system. It may enable passwordless transactions, improve interoperability between different platforms, and enhance the overall efficiency of email-based authentication and secure e-commerce transactions.

An email interface module 147 may be configured to parse emails for action by the Authentication system 140.

The account management unit 148 is configured to manage accounts registered with the Authentication system 140. A customer or vendor wishing to complete a transaction with an Authentication system 140 may register his/her email address and payment information with the Authentication system 140. The account management unit 148 may be configured to store a customer registry and a vendor registry.

The core 149 refers to the central processing and decision-making unit within the authentication system 140 that handles authentication, validation, and transaction processing. It may serve as the primary control unit responsible for executing security protocols, managing user authentication requests, and coordinating secure transactions between customer devices, vendors, and other system components.

Core 149 may perform several key functions, including verifying customer credentials through methods such as DomainKeys Identified Mail (DKIM), Sender Policy Framework (SPF), and Domain-based Message Authentication, Reporting, and Conformance (DMARC). It may also decode tokens embedded in authentication messages, analyze incoming requests for anomalies, and determine whether to approve or deny access based on predefined security thresholds.

Additionally, core 149 may interact with artificial intelligence and machine learning components (such as AI/ML 182) to enhance fraud detection, assess behavioral patterns, and adapt authentication protocols dynamically. It may also manage communication between various system components, including APIs, secure messaging units, and blockchain modules, ensuring that all transactions follow the required security and validation steps. By handling these essential functions, core 149 may serve as the backbone of the authentication system, enabling seamless, secure, and intelligent transaction processing.

The security module 162 may be configured to perform additional security measures to prevent unauthorized access to the system or fraud. the security module may provide various mechanisms to enhance the security of email-based authentication, transaction processing, and user account protection. The security module may be configured to detect, prevent, and respond to security threats such as unauthorized access, phishing attacks, identity spoofing, and fraud attempts. It may work in conjunction with other components of the authentication system 140 to ensure secure communication and transaction integrity between vendors, customers, and third-party service providers.

The security module 160 may support multiple layers of authentication and verification, including email authentication protocols such as DomainKeys Identified Mail (DKIM), Sender Policy Framework (SPF), and Domain-based Message Authentication, Reporting & Conformance (DMARC) to validate email authenticity and prevent email spoofing. It may also monitor and analyze transaction requests using machine learning (ML) and artificial intelligence (AI) techniques to detect anomalies, suspicious activities, or potential fraudulent behavior.

Additionally, the security module 160 may facilitate biometric authentication, digital fingerprinting, and passkey verification to enhance user authentication. It may integrate with external authentication services or security frameworks such as FIDO2, OAuth, and multi-factor authentication (MFA) to provide an additional layer of protection. For real-time monitoring and risk assessment, the security module may track various parameters, including device metadata, geolocation data, IP addresses, and behavioral patterns, to determine whether a transaction request is legitimate or requires further verification.

To further mitigate risks, the security module 160 may generate secure tokens and encrypted session identifiers to facilitate secure communications between the authentication system 140, vendors, and customer devices. It may also support real-time alerts and notifications to inform users of any suspicious activities, allowing them to take corrective actions promptly. The security module 160 may be configurable based on vendor-specific security policies, enabling vendors to define custom authentication rules, fraud detection thresholds, and risk management settings tailored to their business needs.

By implementing these security measures, the security module 160 may ensure that email-based authentication and transaction processing remain robust, reliable, and resistant to cyber threats. Its integration with other components of the authentication system 140 may provide a scalable and adaptable security framework that enhances user trust and minimizes security vulnerabilities in passwordless authentication and secure e-commerce transactions.

In some instances, the security module 162 may utilize blockchain technology to enhance the integrity, transparency, and security of authentication and transaction processes. Blockchain's decentralized and immutable nature may provide several advantages, particularly in securing authentication records, verifying user identities, and preventing fraud.

One way the security module may use blockchain is by recording authentication events and transaction data as immutable ledger entries. Each authentication request, approval, or denial may be stored as a block that is cryptographically linked to previous records. This may prevent unauthorized alterations, as every entry is verifiable and tamper-proof. In scenarios where multiple parties (e.g., customers, vendors, and third-party authentication services) are involved, a private or consortium blockchain may be used to maintain a shared, trustworthy record of authentication attempts and secure transactions.

Additionally, blockchain may facilitate decentralized identity management, reducing reliance on centralized password-based authentication. A customer's biometric data, device fingerprints, or cryptographic keys may be stored in a hashed or encrypted format on the blockchain, allowing for secure verification without exposing sensitive information. Smart contracts may be implemented to automate authentication and transaction approvals, ensuring that access is granted only when predefined security conditions are met. For example, if a customer device submits an authentication request, a smart contract may verify the cryptographic signatures, check for anomalies, and automatically grant or deny access based on blockchain-stored policies.

Furthermore, the security module may integrate blockchain-based anomaly detection by comparing incoming authentication requests with historical blockchain records. If an authentication attempt deviates from established patterns (such as an unusual geographic location or device configuration), the system may trigger additional security measures, such as requiring multi-factor authentication (MFA) or alerting the user.

By leveraging blockchain, the security module may enhance the security, reliability, and efficiency of authentication and transaction processes, ensuring that all interactions remain verifiable and resistant to manipulation.

AI/Machine Learning Unit 182 may serve as a core component of the authentication system 140, performing data analysis, decision-making, and automation of secure transactions and account updates. This unit may be configured to evaluate incoming messages, identify patterns, detect anomalies, and execute actions based on predefined criteria and learned behaviors. By leveraging AI and ML techniques, the system may process large amounts of data, enhance security, and reduce the need for manual intervention in authentication and transaction processing.

The AI/ML Unit 182 may operate by analyzing email messages, transaction requests, and user behaviors to authenticate and validate communications. It may evaluate various factors such as sender identity, message content, metadata, digital signatures, and historical transaction records. The unit may apply supervised and unsupervised learning models to classify messages, detect fraud, and identify suspicious patterns. For example, it may determine whether an email requesting an account update is legitimate or a phishing attempt based on prior interactions, user behavior, and known fraud indicators.

Beyond security, the AI/ML Unit 182 may automate decision-making for account updates and secure transactions. It may interpret customer instructions embedded in messages, extract relevant details, and compare them against vendor databases and historical user preferences. If an action is supported, the unit may execute the update, such as processing a payment, modifying account credentials, or adjusting delivery information. In cases where AI confidence is low or additional verification is required, the system may prompt the user for further confirmation. The integration of AI/ML may enhance the efficiency, accuracy, and adaptability of the authentication system, allowing it to continuously improve and respond to evolving threats and user needs.

The email service provider 170 may be associated with the vendor system 120, the Authentication system 140, or may be a third-party entity. The email service provider 170 may be configured to provide email marketing services. The email service provider 170 may further be configured to provide tracking information showing the status of emails sent to each member of an address list. The email service provider 170 may further be configured to segment an address list into different interest groups or categories to send targeted information. The email service provider 170 may also parse messages based on the secondary system of email-targeted tokens. The email service provider 170 may also be configured to send trigger emails based on responses from the vendor system 120 or customer behavior. The email service provider 170 may further be configured to create or use templates generated by the Authentication system 140. The templates may be used for sending information to contacts. Email service provider 170 may include a customer interface that allows a customer to adjust the template, or it may be integrated with external sources (e.g., vendor system 120 or Authentication system 140) . The email service provider 170 may comprise a send engine (not shown), which allows vendors to distribute their message that may be received by one or more customer device(s) 150. The email service provider 170 may further include a tool for generating mailto links, graphic buttons, and tokens. The email service provider 170 may be configured to dynamically customize the content of emails that are sent out, to tailor personalized information and mailto links.

The banking server (not shown) may be controlled by a third-party system bank. The Authentication system 140 may communicate with the banking server to verify that the customer has adequate funds or credit for the requested payment. For example, the banking server may be controlled by VISA, AMERICAN EXPRESS, MASTERCARD, or any other banking or financial network that a customer may use for online payment. The banking server may be an automatic clearing house service (ACS). The banking server may be an interface for a centralized or decentralized virtual currency system or protocol such as frequent flyer miles, “reward” points, or Bitcoin.

The Authentication system 140 may allow vendors to send advertising emails or bills with a mailto link associated with a specific product offer (or payment amount) and select the mailto link and generate a response email by selecting the mailto link. This response email contains a token and is addressed to the Authentication system 140. Once sent, this response email confirms the customer's payment for the product (or prepayment of a bill) by parsing the information in the token. The Authentication system 140 processes the payment and notifies the vendor system 120 and the customer device 150. The Authentication system 140 may comprise a token generator 141 as well as components for processing the tokens and components for processing the payments, and a system for notifying the vendor system 120 of the transaction details. In addition, the Authentication System 140

The functionality of the offer, mailto link, and response email is described in U.S. Pat. No. 9,152,980, which was issued on Oct. 6, 2015, entitled EMAIL-BASED E-COMMERCE, which is a continuation of U.S. Pat. No. 8,775,623, which was issued on Jul. 8, 2014, entitled SYSTEM AND METHOD FOR EMAIL-BASED E-COMMERCE, and U.S. Pat. No. 9,058,591 which issued on Jun. 16, 2015, entitled EMAIL-BASED DONATIONS, which applications are incorporated by reference as if fully set forth.

Referring back to the example system in FIG. 1, the external payment processing system 160 may be an independent third-party operated unit; it may be located in the Authentication system 140 or the vendor system 120.

While the example system shown in FIG. 1 shows the Authentication system 140 comprising the token generator 141, this is shown as an example only. The vendor system 120 may also include a token generator 141 that allows vendors to create tokens directly. In another example, a third party may have a token generator 141 to create tokens for use by the vendor system 120.

Mailto links in the email messages may include one or any combination of the following fields: a “mailto:” and/or “to” field that indicate one or more email addresses of recipients of the new message; a “Copy To” or “CC” field that indicates one or more email addresses of recipients to whom a copy of the new message should be sent; a “Blind Copy To” or “BCC” field that indicates one or more email addresses of recipients to whom a “blind” copy of the new message should be sent; a field that indicates the subject of the new message; and a field that indicates the body of the new message. The mailto links may be defined according to the format described in Internet Engineering Task Force (IETF) RFC2368, which is incorporated by reference as if fully set forth herein. The mailto link may be accessed with a corresponding short URL.

The Authentication system 140 may include a database of registered customers, such as for payment processing. The Authentication system 140 may identify a customer by their email address and may decode tokens included in the content of an email and process transactions based on the data in the token. A vendor that is associated with the Authentication system 140 may send emails with the tokens generated for processing by the Authentication system 140. When generating tokens, a related URL checkout page with a matching offer is generated. This allows vendors via vendor system 120 to send emails with payment options, including payments for product offers, donations, services, and gift cards, for example, with each offer associated with a token and a URL checkout page. The token is associated with a mailto link. A customer may activate the mailto link by selecting (or “clicking on”) the link and send the message to the Authentication system 140. The Authentication system 140 may then identify the email address and decode the token. If the Authentication system 140 determines that the email address is not registered in the database, the Authentication system 140 sends an email back to the customer with a URL link that is a link for registration. This registration is prepopulated based on the customer's mailto link selection based on the content of the token. The URL captures the customer's information and registry information. The Authentication system 140 updates the database once the new customer is registered. In future transactions, the email address of the customer is identified as registered by the Authentication system 140.

A Security Network 100, as described herein, allows an email payment opportunity. This may include an email advertisement offering a product or service which is sent to customers and contains one or more mailto links. Each mailto link may relate to an item (e.g., service or product). If the mailto link is selected by a customer, an email message associated with an item or items is generated. Within that generated email message is a token that includes encoded information such as the purchase amount, the merchant, or an item identifier. The information contained in the token includes details for both the completion of an email transaction and details that provide context and direction for the process of completing a transaction when the details included within the token are not sufficient. This may include details about the composition of a page to collect more information from the customer (where the required fields and information about those fields are stored directly in the token), a pointer to a location where the composition of a page to collect more information is stored (where the required fields and information about these fields are indirectly referenced by data in this token for retrieval at a later time), or a pointer or description of a routine to execute in case of failures (e.g., a response email in the case of product unavailability). This mailto link may be generated by a vendor through a web interface tool or by using the e-commerce Security Network 100 to programmatically create either the token or the full mailto link.

For a customer to complete an email transaction, the customer's payment information may be contained in the email e-commerce system database 163. In order to determine if the customer's payment information is in database 163, the token may be decoded to recognize the customer when the email arrives at the Authentication system 140. The vendor sends the first email via the vendor system 120. The customer via customer device 150 responds by activating a mailto link by sending the response to the Authentication system 140. If the customer is registered and the incoming email is authenticated, when the token is decoded, the transaction is processed.

If the customer is not registered, a web checkout page may be needed. Additional information may be encoded within the email token that describes a web checkout page for the email offer. The vendor's email may thereby serve multiple purposes. One enables the email to perform as an email payment if the customer is registered, and another enables the unregistered customer to be sent a web checkout 164. The web checkout 164 may be prepopulated with additional information based on the customers' original selection that is decoded from the token. The additional information included within the token identifies remote resources, which may include an input display and validation components. The remote resource may function as a plug-in, as a reference to information stored in a database, or as a hook into the execution of an independent function.

When the web checkout 164 page is being loaded by the customer, the input display may provide the requirements for displaying the field on the form, including field name, entry box length, and other properties of the input field.

When the form has been filled out by the customer and is submitted, these form fields are sent to the validation resource to confirm that the information entered meets the formatting, length, data type, and any other requirements of the field. If validation resource returns a “pass” condition for the form, submission continues to the Authentication system 140. If the validation resource returns a “fail” condition for any data on the form, error messages may be displayed to the customer to enable correction of the one or more particular inputs that were identified as incorrect and resubmission again.

These remote resources may be created to describe standard information that may be used across numerous merchants, or they may be used to define custom information that may be used for a single merchant.

Using this Security Network 100, a vendor via vendor system 120 may not be required to expend additional computer programming effort because it relies on the Authentication system 140. If the offer web page is linked to the email purchase opportunity, the vendor may not be required to modify any existing systems or processes to register customers with the Authentication system 140. The vendor may not need to segment their email lists into registered and unregistered customers, and the customers are not aware of the distinction within the content of the email. The distinction between customers occurs by virtue of the system, relieving both the vendor and the customer of any excess choices or distinctions. The vendor may create offers manually via a web interface, and the Authentication system 140 may handle the aspects of the transaction, from receiving the order request, facilitating the payment processing, storing relevant transaction data, sending a receipt, and displaying transaction data to the vendor.

The vendor may integrate directly with an API. The vendor may maintain existing payment flows separate from their email e-commerce solution, or the vendor may use the email e-commerce system as a full-featured payment system for both web and email transactions without doing any software development. Presenting the customer with a clear process that seamlessly migrates the customer to adopt an email-based checkout process eases the customer into a new technology where transactions happen by email instead of on a URL. This Security Network 100 provides a vendor with a more automated or customized way of handling elements that may be achieved through the use of the Authentication system 140.

The disclosed methods provide different benefits based on the dynamic nature of the Authentication system 140. The Authentication system 140 offers vendors 120 multiple methods to hold and transfer funds via email, SMS, or social media message. The Authentication system 140 also offers a flexible configuration of the system allowing the vendor 120 or other third parties to hold desired parts of the system in the vendor system 120. For example, the token generation which is depicted in FIG. 1 as being held by the Authentication system 140 may be held by another party. When the vendor 120 registers with the Authentication system 140, they may be offered different levels of service, and the vendor 120 may choose the configuration required.

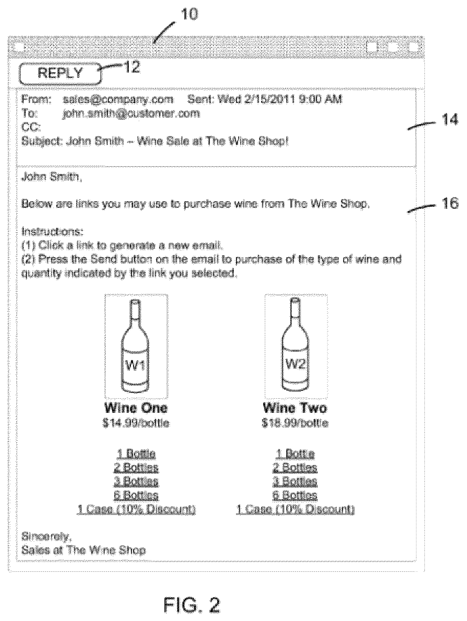

FIG. 2 illustrates an example email message that solicits the purchase of goods from a vendor. FIG. 2 shows an email display window 10 that may be used by the email client module of customer device 150 to display the first example email message from the message processing module. The email display window 10 may include a reply button 12, a control area 14, and a message body area 16. The control area 14 may display control and/or header information associated with the email message, such as the email addresses of the sender and recipient of the message. According to this example, the control area 14 shows that the sender of the message has the email address “sales@company.com.” This is an email address that may be associated with an account used by the Authentication system 140 for the communication of email messages. Further to this example, the control area 14 shows that the email address of the example recipient of the message (John Smith) is “john.smith@customer.com.” The control area 14 may also display information such as the subject of the email message and the time the email message was sent. The reply button 12 may respond to user input to generate a new display element (not depicted) to respond to the email message.

The message body area 16 may display the body of the email message. As shown in FIG. 2, the message body area 16 may display an example email message that shows information related to two example products (Wine One and Wine Two) that are being offered for sale by an example vendor (The Wine Shop). The message body area 16 includes a picture of a bottle of each type of wine, as well as the price for a bottle of each type of wine. The message body area 16 also includes, under the picture of the bottle of Wine One, a number of mailto links, such as the “1 Bottle,” “2 Bottles,” “3 Bottles”, “6 Bottles,” and “1 Case (10 percent Discount)” links. The message body area 16 also includes similar links under the picture of the bottle of Wine Two. These links may be defined according to the mailto URI scheme or other appropriate formats, and each may describe a new email message that may be generated by the email client module of customer device 150 when that link is selected.

The “1 Bottle” link beneath the picture of the Wine One bottle may include information that, if selected, generates an email message that, if received by the Authentication system 140, will indicate to the Authentication system 140 that John Smith may like to purchase one bottle of Wine One. As a further example, Wine One may have a product identifier of “0005,” and John Smith may have a customer identifier of “0777.” According to this example, the “1 Bottle” link may describe an email message that is addressed to an email account that is associated with the Authentication system 140, and that includes a message body that includes the identifier for John Smith (“0777”), an identifier of the selected product (“0005”), and an identifier of the quantity that John Smith may like to order (in this example, a single bottle). Alternatively or additionally, the email message described by the link may include information such as text that describes the order, an identifier of the vendor (in this example, The Wine Shop), an email campaign identifier, and/or other information. Similarly, the “2 Bottles” link beneath the picture of the Wine One bottle may include information that describes an email message that, if received by the Authentication system 140, will indicate to the Authentication system 140 that John Smith may like to purchase two bottles of Wine One. According to this example, the “2 Bottles” link may be defined as follows:

<a href=“mailto:sales@company.com?subject=Purchase percent 20from percent 20Wine percent 20Shop percent 20 and body=You percent 20have percent 20created percent 20an percent 20order percent 20for percent 20two percent 20bottles percent 20of percent 20Wine percent 20One. percent 20Press percent 20the percent 20Send percent 20button percent 20to percent 20complete percent 20the percent 20order. percent 0A percent 0AProductID0005 percent 20QualifierNA percent 20Qty0002 percent 20CustomerID0777 percent 20CampaignID0003” target=“_blank”>2Bottles</a> mailto:sales@company.com?Subject=“Press send to pay $42.99 to Wine Shop”? body=“TEXT XXX-XXX-XXX-XXX”

In addition, the token identifier may be part of the To: address, or any other portion of an address field, or the address field itself. This token may be, for example, of the form: ex: mailto:payment-id-XXX-XXX-XXX@payments.atpay.com? Subject=“Press send to pay $42.99 to Wine Shop”?body=“TEXT”. Once this token identifier reaches the Authentication system 140, the Authentication system 140 may perform a lookup of the actual token in order to parse the offer details. This process is described in greater detail below.

Similarly, the “3 Bottles,” “6 Bottles,” and “1 Case (10 percent Discount)” links beneath the picture of the Wine One bottle indicate corresponding information for three bottles, six bottles, and one case of bottles, respectively. Additionally, the “1 Bottle,” “2 Bottles,” “3 Bottles,” “6 Bottles,” and “1 Case (10 percent Discount)” links under the Wine Two bottle indicate corresponding information for Wine Two as that described above with respect to the mailto links relating to Wine One.

The email client module of customer device 150 may receive a user input that indicates that one of the links displayed in the message body area 16 is selected. The user input may be, for example, a mouse click, keyboard input, or any other type of input that indicates that a link is selected. The email client module of customer device 150 may, in response to this user input, generate and display an order email message as specified by the selected link.

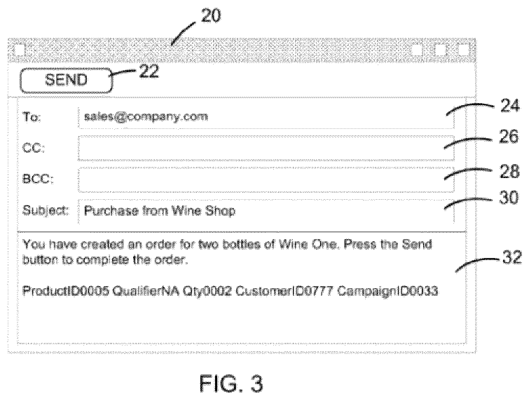

FIG. 3 illustrates an email message for placing an order. FIG. 3 shows an example message composition window 20 that may be displayed in response to a selection of a link from the message body area 16 of the email display window 10 of FIG. 2. The message composition window 20 of FIG. 3 may include a Send button 22, a To area 24, a CC area 26, a BCC area 28, a Subject area 30, and a message body area 32. The Send button 22 in the message composition window 20 of FIG. 3 may be responsive to input from a user, such as a mouse click, keyboard input, or any other type of input. The different areas 24, 26, 28, 30, 32 in the message composition window 20 display different portions of an email message. For example, the To area 24 includes text that indicates email addresses to which the email message is addressed, while the message body area 32 displays the contents of the body of the email message. Each or any of these different areas 24, 26, 28, 30, 32 may be editable based on user input. Changes to the contents of these areas 24, 26, 28, 30, 32 may change the corresponding portion of the email message.

FIG. 3 shows an example wherein the “2 Bottles” link beneath the picture of the Wine One and described above with reference to FIG. 2 is selected. The To area 24 indicates that the message is addressed to sales@company.com. The Subject area 30 indicates that the subject of the message is “Purchase from Wine Shop.” The CC area 26 and BCC area 28 are blank. Continuing the example of FIG. 3, Wine One product has a product identifier of “0005” and John Smith has a customer identifier of “0777.” Accordingly, the message body area 32 includes the text “ProductID0005” and “CustomerID0777.” To indicate that the user has selected the purchase of two bottles, the message body area 32 includes the text “Qty0002.” Further, the message body area 32 includes the text “CampaignID0033,” indicating that the order is associated with an email campaign with an identifier of “0033.”

In an instance where a different link from the message body area 16 of FIG. 2 is selected, the display areas 24, 26, 28, 30, 32 in the message composition window 20 may include contents specified by the selected different link. For example, in an instance where a link related to Wine Two is selected, the message body area may not include the text “ProductID0005,” but may include text that indicates the corresponding identifier for Wine Two.

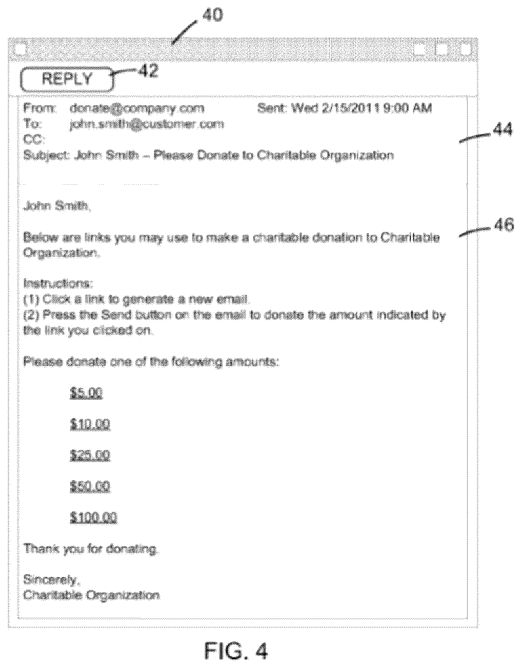

FIG. 4 illustrates an advertisement email message that solicits a donation. FIG. 4 shows an email display window 40 that may be used by the email client module of customer device 150 to display a second example email message from the message processing module. The email display window 40 includes a Reply button 42, a control area 44, and a message body area 46. These display areas 42, 44, 46 may possess similar and/or analogous characteristics and/or perform similar functionality as corresponding display areas 12, 14, 16 in the message composition window 20 of FIG. 2. According to the example of FIG. 4, the control area 44 shows that the sender of the message has the email address “donate@company.com.” This is an email address that may be associated with an account used by the Authentication system 140 for the communication of email messages. Further to this example, the control area 44 shows that the email address of the example recipient of the message (John Smith) is “john.smith@customer.com.”

As shown in FIG. 4, the message body area 46 of the email display window 40 may display an example email message that shows information related the solicitation of donations, for example, a non-profit organization (“Charitable Organization”). The message body area 46 also includes mailto links, such as the “$5.00,” “$10.00,” “$25.00,” “$50.00,” and “$100.00” links. These links may possess similar and/or analogous characteristics and/or include similar and/or analogous information, as the mailto links described above with reference to FIG. 2. The “$5.00” link describes an email message that, if received by the Authentication system 140, will indicate to the Authentication system 140 that John Smith may like to donate $5.00 to Charitable Organization. Similarly, the “$10.00,” “$25.00,” “$50.00, and $100.00” links describe email messages with corresponding information for $10.00, $25.00, $50.00, and $100.00 donations, respectively.

The email client module of customer device 150 may receive a user input that indicates that one of the links displayed in the message body area 46 is selected. The email client module of customer device 150 may, in response to this user input, generate and display an order email message as specified by the selected link.

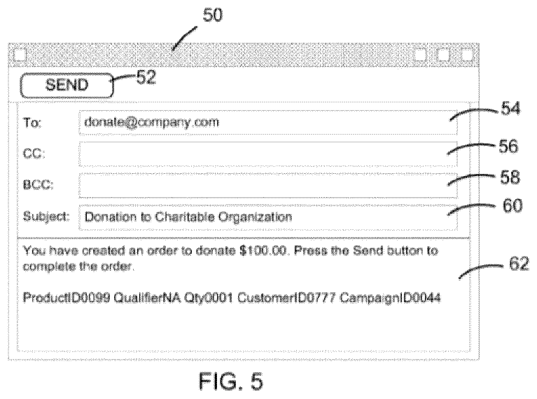

FIG. 5 illustrates an email message for ordering a donation. FIG. 5 shows an example message composition window 50 that may be displayed in response to a selection of a link from the message body area 46 of the email display window 40 of FIG. 3. The message composition window 50 of FIG. 5 may include a Send button 52, a To area 54, a CC area 56, a BCC area 58, a Subject area 60, and a message body area 62. These display elements 52, 54, 56, 58, 60, 62 may possess similar and/or analogous characteristics and/or perform similar functionality as corresponding display areas 22, 24, 26, 28, 30, 32 in the message composition window 20 of FIG. 3.

FIG. 5 shows an example wherein the “$100.00” link from the message body area 46 of the email display window 40 of FIG. 4 is selected. The To area 54 indicates that the message is addressed to donate@company.com. The Subject area 60 indicates that the subject of the message is “Donation to Charitable Organization.” The CC area 56 and BCC area 58 are blank. According to this example, a donation of $100.00 to Charitable Organization has a product identifier of “0099,” and John Smith has a customer identifier of “0777.” Accordingly, the message body area 62 includes the text “ProductID0099” and “CustomerID0777.” Further, the message body area 62 includes the text “CampaignID0044,” indicating that the order is associated with an email campaign with an identifier of “0044.”

The email client module of customer device 150 may send the generated order email message to the Authentication system 140. This may be performed in response to input from a user of the customer device 150. As one example, the email client module of customer device 150 may, in response to a selection of the Send button 52 in the message composition window 50 of FIG. 5, transmit an order email message based on the contents of the fields 54, 56, 58, 60, 62 in the message composition window 50. As another example, the email client module of customer device 150 may, in response to a selection of the Send button 52 in the message composition window 50 of FIG. 5, transmit an order email message based on the contents of the display areas 54, 56, 58, 60, 62 in the message composition window 50.

A token may be located within the To: Cc: or Bcc fields of a response email. This token may take the form of a short token, for example. The Authentication system 140 may generate the short token that is located in the To: field, or any other field, for example, as part of the email address. When the vendor system 130 requests that the token generator 141 generate a mailto link with the identifiers and token, the token generator 141 may generate a “short lookup token” and the “long token” encoded with the identifiers. The short lookup token may be associated with the long token and may be required or otherwise needed to access the information in the long token index. The short token index may be sent in an email to the customer device 150 as a mailto link. The customer using the customer device 150 selects the mailto link and generates the response email addressed to the Authentication system 140. The short lookup token may be built into the address of the response email. The short lookup token may be of the form:

payment-id-74E4DE00-51E2-457B-8C0B-648640EF232D@payments.atpay.com, for example.

When the customer using customer device 150 sends the email and the Authentication system 140 receives the email and authenticates the customer's email address, the Authentication system 140 may also determine using the short lookup token included in the email address of the Authentication system 140 the long token associated therewith. When the long token is determined, the Authentication system 140 decodes the long token and processes the payment. The use of the short token allows for a less convoluted field in the email address and eliminates the need for the token to be located in the body field.

The short token lookup is not necessarily required in this system, as the transactions may be processed with the long token either in the address field, another field, or in the body of the response email. The use of the short lookup token may lessen the one-to-one correlation between the token and the actual offer and/or transaction details, as that correlation may be more direct in the long token embodiment.

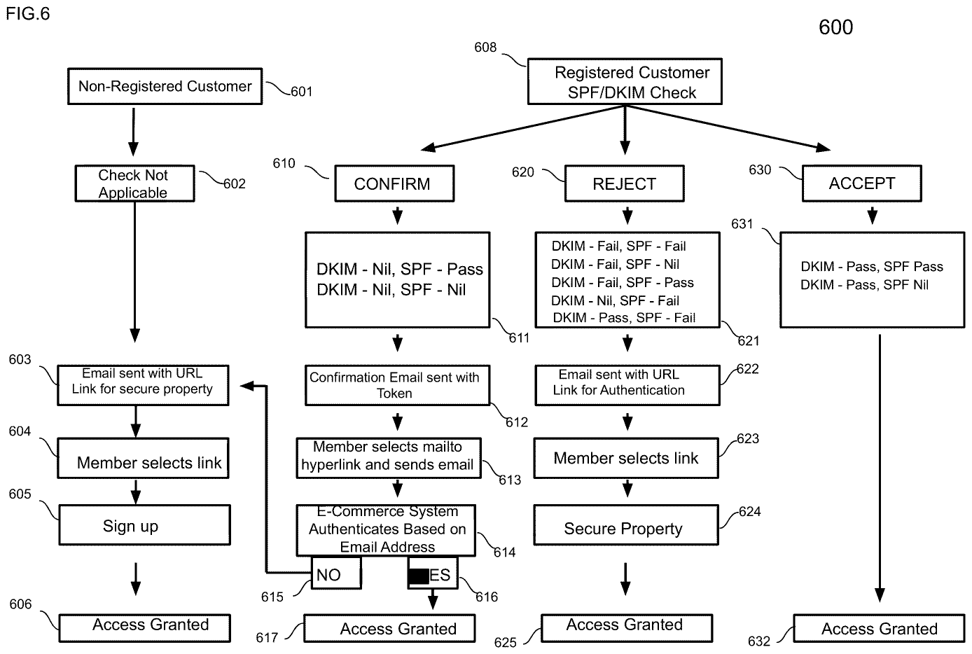

FIG. 6 is a flow diagram 6000 of an authentication system 140 that authenticates received emails from registered and non-registered customers utilizing DKIM/SPF in order to grant access to a secure web page. However, access to a secure webpage is, for example, only and in other instances, access may be granted to an online shopping cart or for granting access to process an order. When the authentication system 140 receives a response email, it must determine whether the response is from a non-registered customer or a registered customer; this may be based, for example, on the email address associated with the sender of the email. Once the authentication system 140 has determined whether the email was sent from a registered or non-registered customer, the Authentication system 140 may determine whether the email was received from an authenticated source.

Whether or not the DKIM and SPF validations succeed, the Authentication system 140 may determine that an email is received from a non-registered customer (step 601). This may be based on, for example, the email address of the customer or information embedded in the email, including the token. If this is the case, the Authentication system 140 may determine that an SPF/DKIM check is not applicable (step 602). The Authentication system 140 may send an email to the non-registered customer with an URL hyperlink for a web checkout (step 603). The non-registered customer may select the URL hyperlink in the email, which directs the non-registered customer to a web page based on the URL (step 604). The non-registered customer may then complete registration on the web page (step 605). This could be a web checkout or access to a secure server. By completing the registration, the non-registered customer may be registered with the Authentication system 140, either automatically or by selecting an option. Access is granted to the secure property (step 606).

The authentication system 140 performs an SPF/DKIM check on the email to check for valid DKIM signatures and SPF records (step 608). These are used to detect whether incoming messages have been mimicked. A mimicked message may be an email message that appears to have been sent by a user but was sent by another user. This may often be seen in spam messages appearing to be from a known source. Based on the authentication procedure, the Authentication system 140 may confirm, reject, or accept the authentication.

In one scenario, after the SPF/DKIM check, the authentication system 140 may determine that a confirmation of the sender is needed (step 610). The confirmation may be requested, for example, based on user preferences, or if the authentication system 140 requests additional information. The authentication system 140 may determine a confirmation is needed when the DKIM is Undefined, and the SPF is either Pass or Undefined (step 611). In this scenario, the authentication system 140 may generate a confirmation email message that includes a mailto link with a token to confirm the identity via an email message (step 612). In this instance, the email and token may be integrated as a secondary system for a single-click experience. When the customer receives the email, they select the hyperlink and generate a response email that they send back to the Authentication system 140 (step 613). When the Authentication system 140 receives the response to the confirmation email message, the Authentication system 140 104 authenticates the customer, based on the email address this message was sent from and the email address embedded within the token (step 614). If this is confirmed as a YES (step 616), then the Authentication system 140 may decode the token and grant access to a secure property or process payment and send notifications to the customer and vendor server (step 617). If the email targeted token arrives back at the authentication system 140 and is not recognized as registered and confirmed as a NO (step 615), then the authentication system 140 may send the customer an email with a URL hyperlink driving them to a signup and web checkout page. This web checkout may be located on the Authentication system 140 or integrated with an API on the vendor server 120, or it may be on a third-party system.

In another scenario, the Authentication system 140 may reject the email (step 620). This may occur when the DKIM Fails, and the SPF either comes up Failed, Undefined, or Passes OR the SPF Fails, and the DKIM is Undefined or Pass (step 621). In this situation, the Authentication system 140 may not confirm the outgoing email server of the received email message. The Authentication system 140 may generate a response email addressed to the customer that includes a URL hyperlink for the messages categorized as Reject (step 622). When this URL hyperlink is selected (step 623), the customer opens a web-based registration and uses the URL to complete registration for the secure property (step 624). This could be a web checkout or access to a secure server. This secure property may be part of the vendor server 120 or hosted by the Authentication system 140. The secure property may also request the user to enter registration information. Once the registration is complete, access is granted in step 625.

In the third scenario, the authentication system 140 accepts the response (step 630) email and is able to successfully authenticate a registered user. For example, this may occur when the Authentication system 140 generates an email address with a token embedded in the email address. This email address with the token may be accessed by a mailto link generated by the Authentication system 140 or may be copy and pasted into the “To” field of an email. That email is addressed to the Authentication system 140. The customer sends the email. Once the email is sent, the DKIM/SPF process begins. If the Authentication system 140 determines that the received email is from a registered customer and both the DKIM and SPF are present and valid, the received message may be categorized and processed as an Accept by the Authentication system 140 (step 631). The token is decoded, and the customer is granted secure access (step 632).

In an alternative embodiment where any customer's message that is categorized as either Non-registered, Confirm, or a Reject may all receive an email response that drives them to a URL. This may be a preference of the vendor or may be in response to other environmental indicators such as the rate of Confirmations, Rejections, and Acceptances the system is currently detecting.

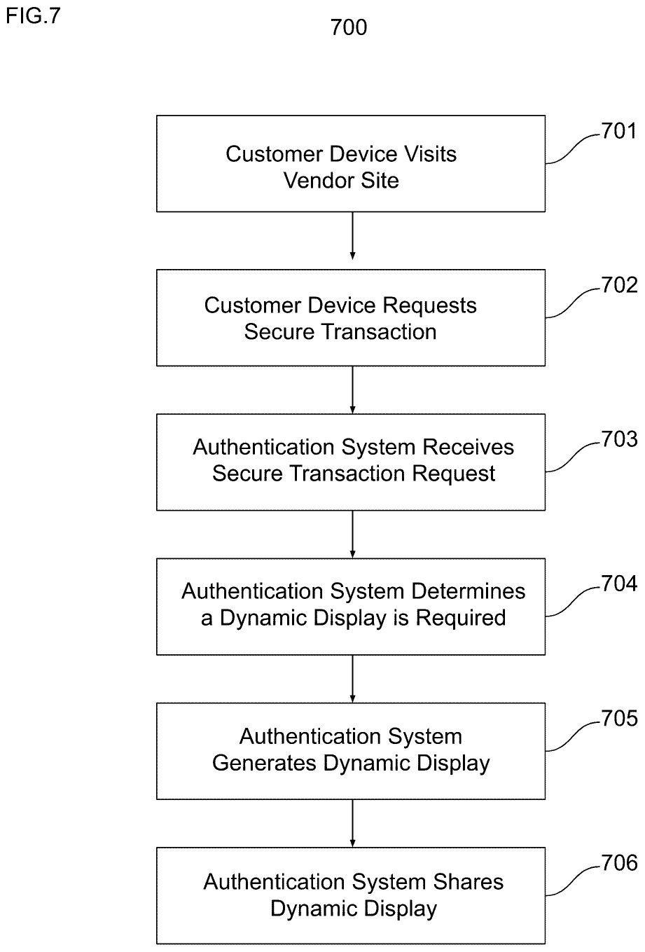

FIG. 7 illustrates a method 700 providing a dynamic display of options for secure transactions. A dynamic display is an adaptive, interactive interface element that changes its content, layout, or functionality in response to specific user actions, contextual factors, or external inputs. This type of display is designed to provide real-time updates and tailored information that enhances the user experience by aligning with the needs or preferences of a customer or vendor.

The dynamic display may include features such as updating product details, pricing, or promotional offers based on the customer's browsing history, preferences, or location. For example, when a customer interacts with the system, the dynamic display could showcase products that align with their past purchases or preferences. Similarly, the display might adjust based on inventory levels, presenting alternative recommendations if a product is unavailable.

This adaptability is achieved through integration with backend systems, such as databases, algorithms, or machine learning models, that analyze real-time data. By employing dynamic displays, the invention facilitates more engaging and personalized interactions between customers and vendors, leading to improved satisfaction and streamlined decision-making processes.

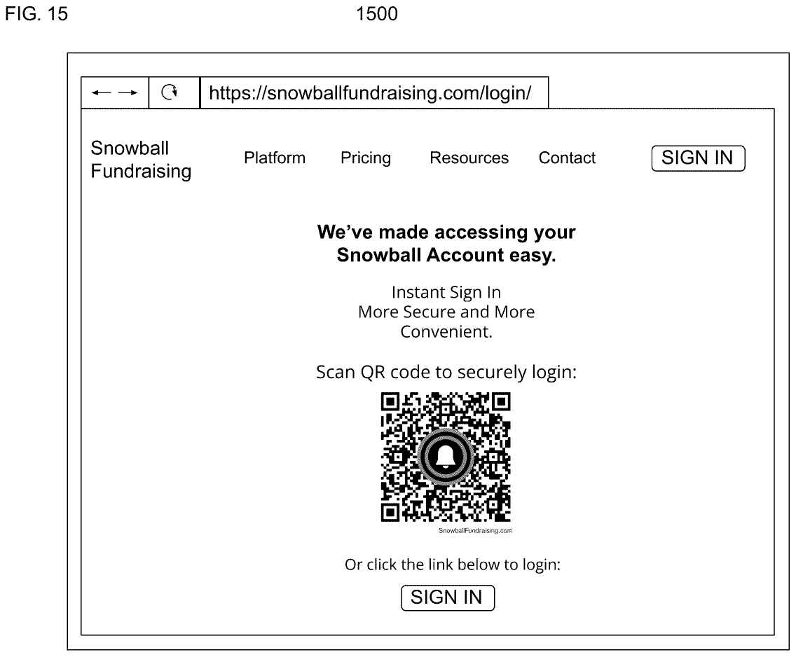

A customer device may vary in design and applications on the user device may have different requirements that require different displays and options. As shown in FIG. 7, Method 700 includes the customer using the customer device 150 to visit the vendor web page at step 701 and using the customer device to request a secure transaction at step 702. This transaction could be user registration, payment or secure access to a server. The authentication system receives the secure transaction request at step 703, and the authentication system determines that a dynamic display is required for this category of secure transaction at step 704. The authentication system generates the dynamic display at step 705 based on the requirements. In this example, the display may require generating a QR code and link that only displays the QR Code on desktop devices, as described in FIG. 15. Alternatively or additionally, the authentication system may determine a different display requirement such as a bar code, image or voice recognition or near field communication. The authentication system shares dynamic display with the customer device at step 706. Dynamic display may be shared between customer device 1 150 and customer device 2 180. For example, the authentication system sharing an update with customer device 1 150 that displays a “Pending” alert on the display of the customer device 1 150 for the duration of time required before the authentication system authenticates the response email from email unit of customer device 2 180 described in steps 1412 and 1612.

The dynamic display can be implemented through a combination of hardware and software systems designed to deliver adaptive and interactive content. On the frontend, technologies such as HTML, CSS, and JavaScript frameworks like React or Angular can be employed to create responsive and visually engaging interfaces. These interfaces may include dynamic elements like carousel banners showcasing featured products, interactive charts for pricing trends, and contextual buttons that adjust their functions based on customer selections. The backend integrates with these interfaces through APIs and databases, ensuring seamless access to real-time information, such as inventory updates, customer preferences, or vendor-specific promotions. Business logic and algorithms in the backend drive decisions about the content displayed, such as highlighting products based on customer behavior or emphasizing high-demand inventory.

To ensure the display remains dynamic and responsive, technologies such as WebSockets can enable real-time communication between servers and clients, allowing updates like price changes or flash sales to be pushed instantly. Event-driven architectures can further enhance responsiveness by triggering updates based on user actions or time-sensitive events. Machine learning algorithms can personalize the display by analyzing customer history and preferences, offering tailored recommendations and predictive insights. These AI-driven systems allow the display to adapt to individual user needs, making the experience more engaging and relevant.

The dynamic display can be deployed across various platforms to maximize accessibility and usability. Web applications ensure compatibility with desktop and mobile browsers, while native mobile apps for iOS and Android can utilize device-specific features like location services and push notifications. Additionally, physical interfaces such as touch-enabled kiosks or store displays can extend the dynamic display to in-person settings, providing real-time interactivity. By integrating these components, the system delivers a sophisticated, context-aware solution that aligns with the invention's goals of providing a personalized and adaptive user experience.

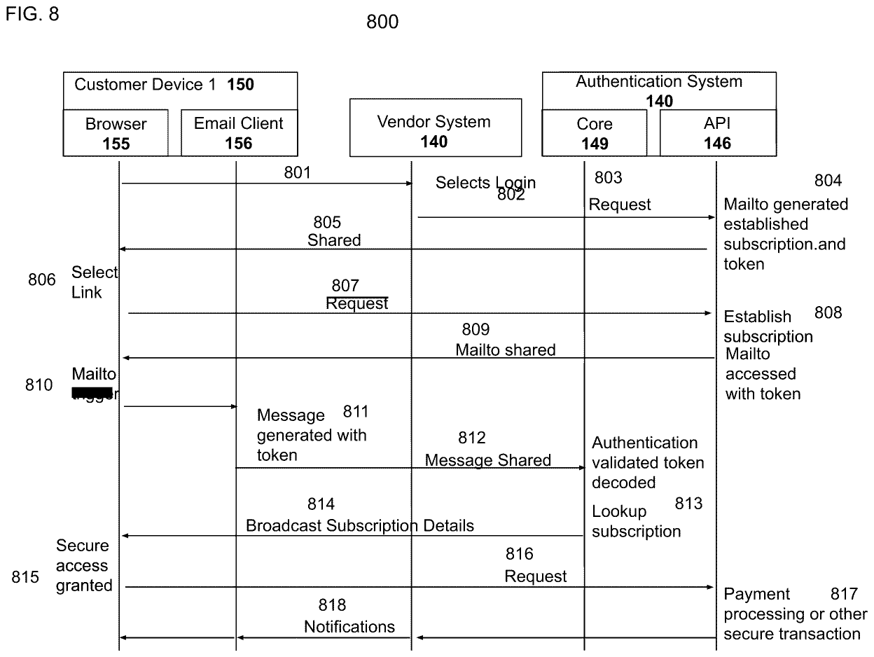

FIG. 8 is a diagram illustrating a method 800 the flow of transactions between the authentication system 140, the vendor 120 and the customer device 150 for granting secure transactions without a password using WebSockets with email-based authentication and a short URL without a password. The disclosed invention allows the customer to access a secure connection without a password by utilizing a unique email authentication method and then maintain a secure channel that enables updates via the customer's browser unit. The authentication system 140 may generate mailto links and tokens for the purpose of granting secure transactions without a password. URLs that generate email messages may substituted for mailto links. The token may contain transaction detail, security keys or secret pins. The authentication of an email message serves as sufficient proof of customer identity. The browser unit of the customer device 150 accesses (801) a web page of the vendor system and selects the option for a secure transaction option (step 802).

WebSockets are a communication protocol that enables full-duplex, bi-directional communication between a client (e.g., a web browser) and a server over a single, persistent TCP connection. Unlike HTTP, which requires a new request-response cycle for each interaction, WebSockets establish a long-lived connection through an initial HTTP handshake and then upgrade to a WebSocket protocol. This allows real-time, low-latency data transfer, making it ideal for applications like chat systems, online gaming, live sports updates, and collaborative tools. Once connected, both the client and server can send messages independently of each other, enabling continuous interaction without the overhead of repeated HTTP requests. The protocol is event-driven, supports seamless communication, and is widely supported in modern browsers and networking environments.

In some instances, an alternative to WebSockets may be utilized. For example, several alternatives to WebSockets exist for real-time communication between a client and server, each with unique characteristics and use cases. HTTP polling is a simple approach where the client periodically sends requests to check for updates, but it is inefficient due to high latency and network overhead. Long polling improves on this by holding the connection open until the server has new data, reducing request frequency but still requiring connection re-establishment, which can be resource-intensive. Server-Sent Events (SSE) is another option that enables the server to push real-time updates to the client over a single, long-lived HTTP connection. While SSE is more efficient for one-way data flow, it lacks bi-directional communication. Protocols like MQTT and AMQP cater to IoT and enterprise applications, offering lightweight messaging and reliable, asynchronous communication through publish/subscribe patterns.

More advanced options include gRPC with bidirectional streaming, which leverages HTTP/2 for real-time data exchange and is well-suited for structured data in microservices. Similarly, GraphQL Subscriptions enable selective real-time updates in applications like collaborative tools, often utilizing WebSocket or other transport layers under the hood. For high-performance scenarios, ZeroMQ and QUIC provide low-latency communication with flexibility but require more implementation effort. Lastly, managed solutions like Firebase Realtime Database offer real-time data synchronization without needing to manage infrastructure. The choice among these alternatives depends on factors like the need for uni- or bi-directional communication, latency sensitivity, scalability, and the complexity of the application.

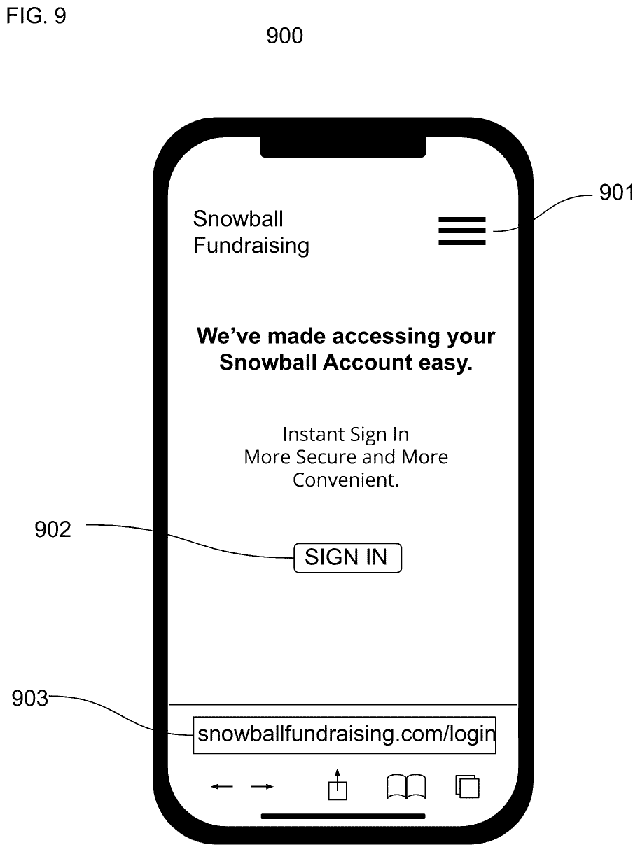

FIG. 9 is an example screen 900 used to request secure account login via the vendor website. The browser unit of the customer device via the vendor 120 accesses (803) the authentication system 140. This page graphically may appear to the customer as the vendor website but is hosted by the authentication system 140. The page may offer the customer any one of several types of requests. It may be a request to make a payment, registration, a reservation, a pledge, access to a secure server, request for a quote or may be a shopping cart function. In this example the customer selects the “Sign in” (902). The authentication system 140 establishes a subscription for the transaction which generates a unique identifier, a short URL link, a long token and a corresponding short token at the API unit 146 (step 804). In some instances, the long token can be omitted. The authentication system 140 shares (805) the short URL Link with the browser unit of the customer device 150. The customer selects the short URL link and requests (806) the mailto with the short token from the authentication system 140. The authentication system 140 establishes the subscription, and accesses the mailto and short token (808). The authentication system 140 then shares (809) the mailto link with short token with the browser of the customer device 150. The mailto link triggers (810) the browser to open the email client of the customer device 150. The mail client of the customer device 150 then generates (811) and sends (912) an email addressed to the authentication system 140 that contains the short token. The email message may contain the token and subscription.

In this context, a subscription refers to a communication pattern where a client subscribes to a data source or service to automatically receive updates whenever the data changes, eliminating the need for repeated requests. Subscriptions are commonly used in real-time applications to ensure that the client remains up-to-date with minimal latency. The process typically begins with the client sending a subscription request to the server, specifying the data or events it is interested in, such as new chat messages, stock price updates, or changes in a database. Once the subscription is established, a persistent connection, often through protocols like WebSockets, is maintained between the client and server. The server uses this connection to push updates to the client whenever relevant changes occur. This approach is efficient and widely used in scenarios requiring real-time updates, such as collaborative tools, live event feeds, or IoT systems. Subscriptions can be implemented using tools like GraphQL, where clients subscribe to specific queries and receive updates through WebSockets, or through publish/subscribe patterns in messaging protocols like MQTT or AMQP, which deliver updates to clients subscribed to specific topics.

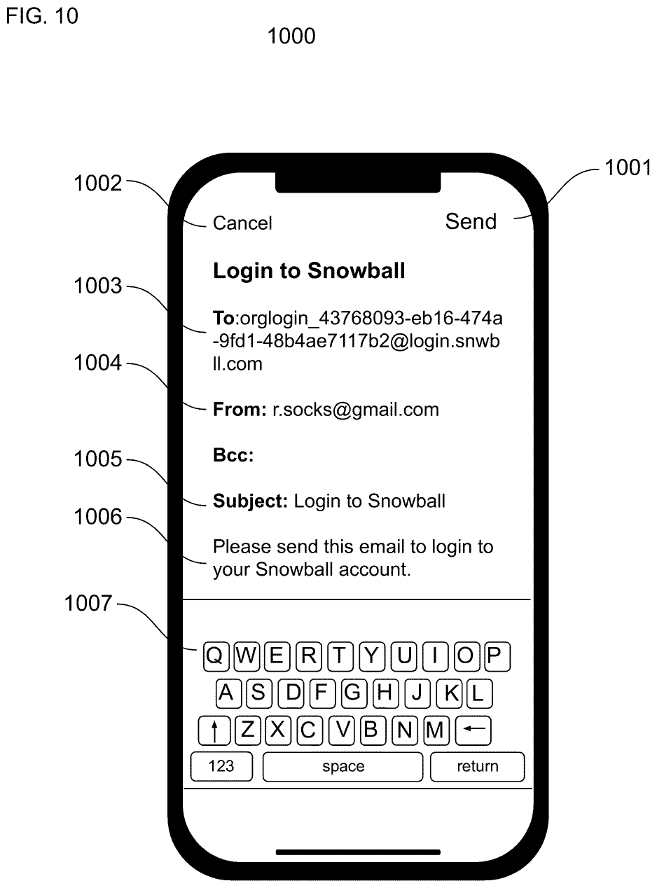

FIG. 10 is an example email message 1000 used for authentication of the transaction. The token may be anywhere in the email. The token may be integrated into the email address (step 1003). The customer may select send to transmit the message to the core unit 149 of the authentication system 140. Alternatively the message may be sent automatically. The core unit 149 performs a series of checks and authentication.

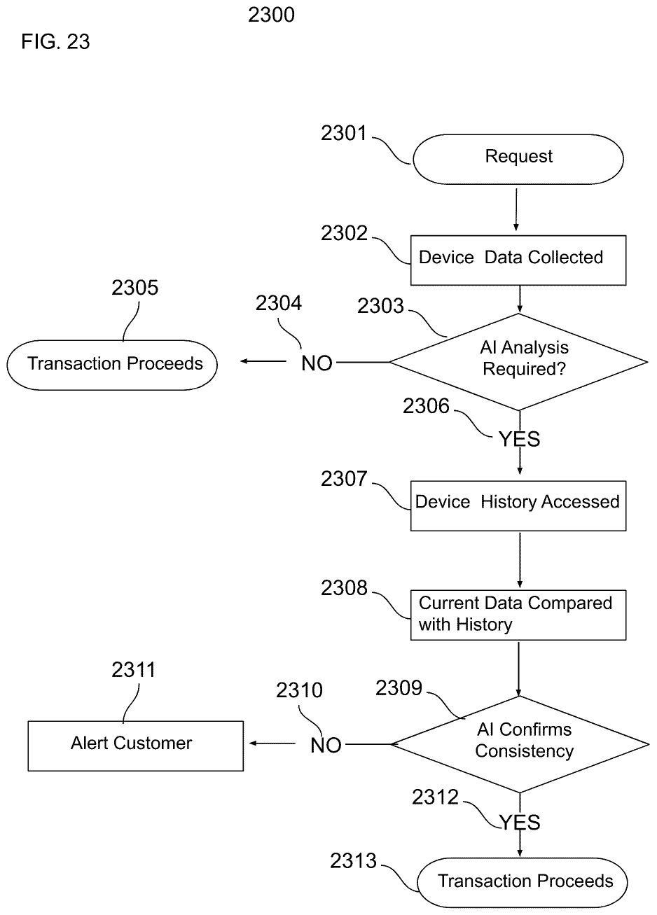

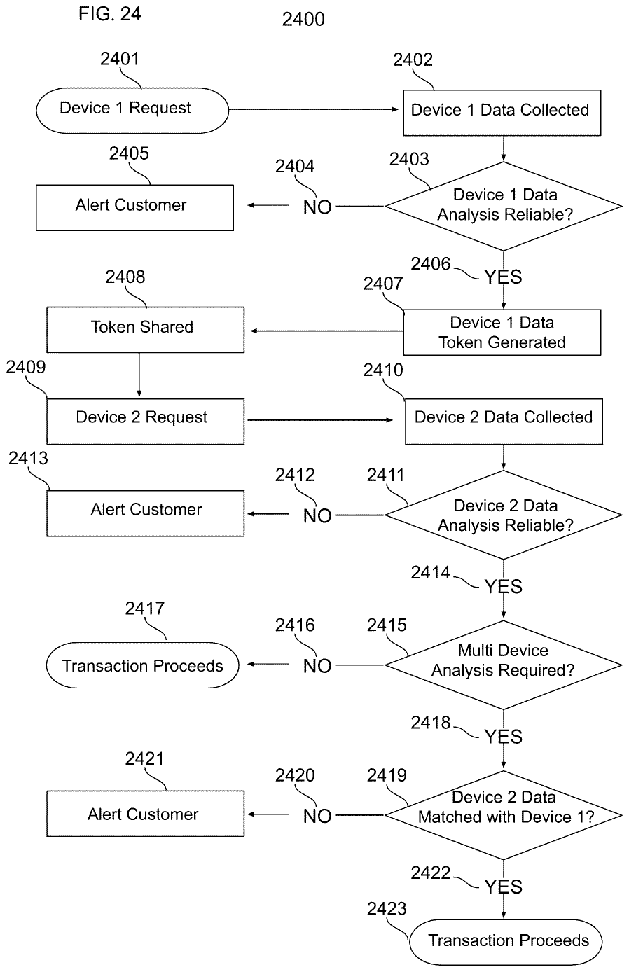

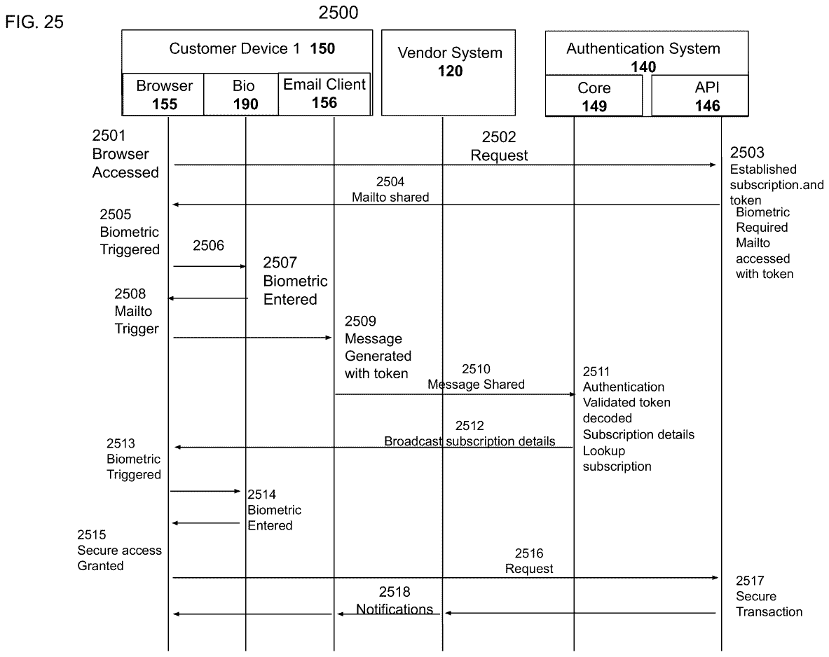

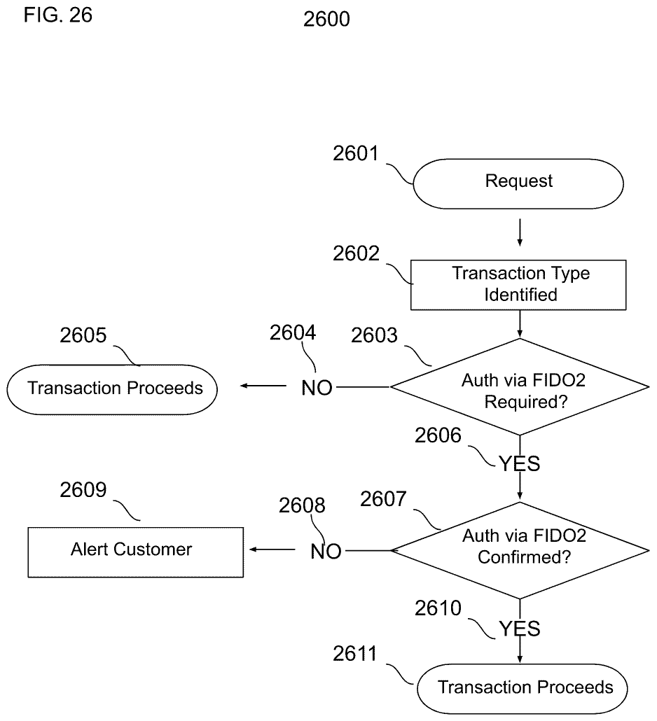

The core unit 149 at the authentication system 140 performs a series of checks and authentication (813). The authentication system 140 authenticates the email using the digital signature. These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes an algorithm to monitor changes to the collected data described in FIG. 24. 5) Artificial Intelligence checks may be employed as described in FIG. 23. 6) Biometric confirmation is confirmed as described in FIGS. 25 and 26.

Based on the checks and authentication results, the authentication system 140 may take various actions in response. If the message is determined to be not secure additional confirmations may be sent to the customer and alerts sent to the vendor and/or domains. The authentication system 140 may validate and authenticate the message. If the message is determined to be secure and authenticated, the short token is matched with the long token and the long token is decoded. Authentication may be limited to DKIM, DMARC or SPF path-base authentication. Only one form of authentication may be required. The authentication system 140 authenticates the digital signature in the customer email. The long token may contain the subscription.

The authentication system 140 may decode the token and perform a lookup with the subscription details. If the message is determined to be secure and authenticated, the transaction proceeds and the authentication system 140 looks up the subscription. The authentication system 140 may determine that all requirements are met and may perform the secure transaction at this point, for example to process the payment. Alternatively or additionally the authentication system 140 may publish a “pledge”, as a customer's intention to make a payment. The published pledge maybe be a publicly visible advertisement. (Not depicted)

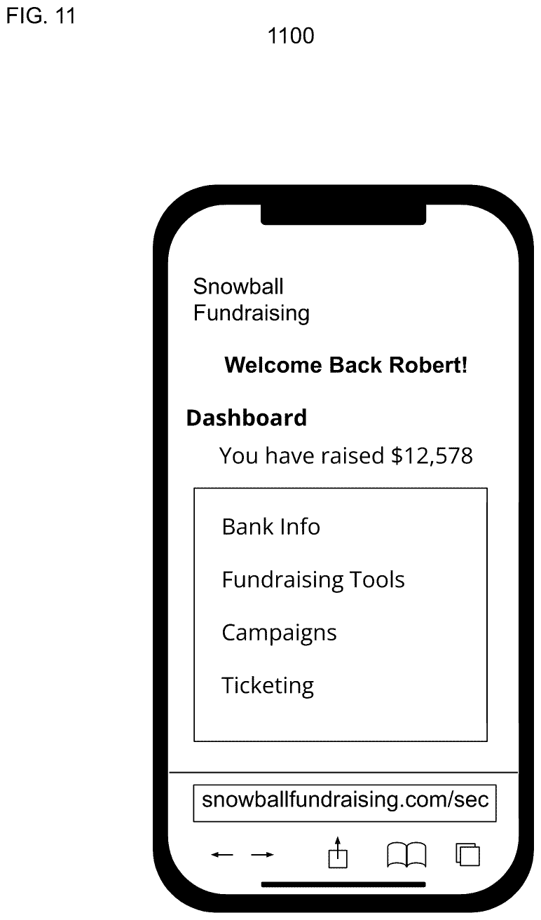

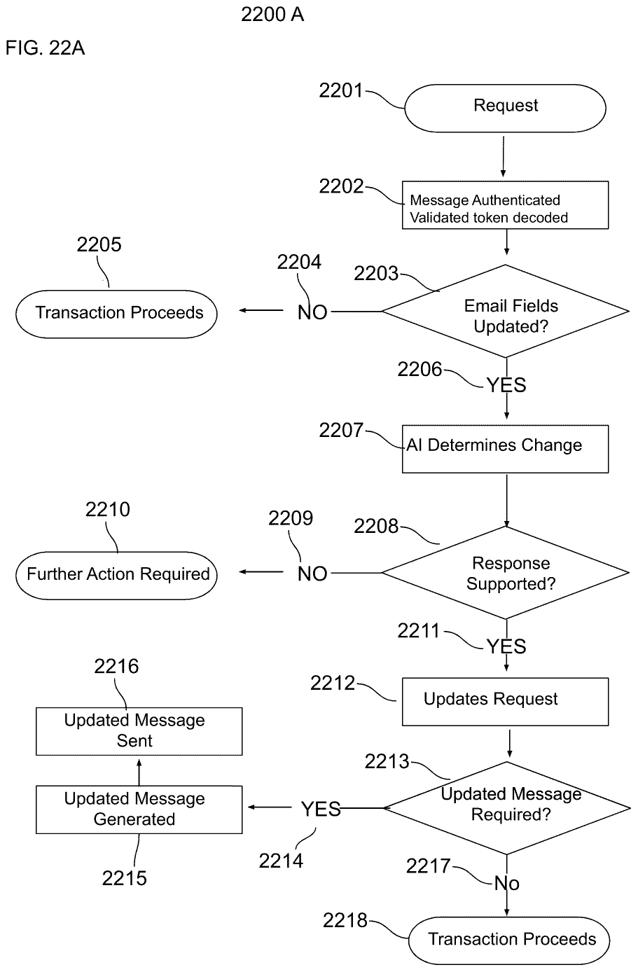

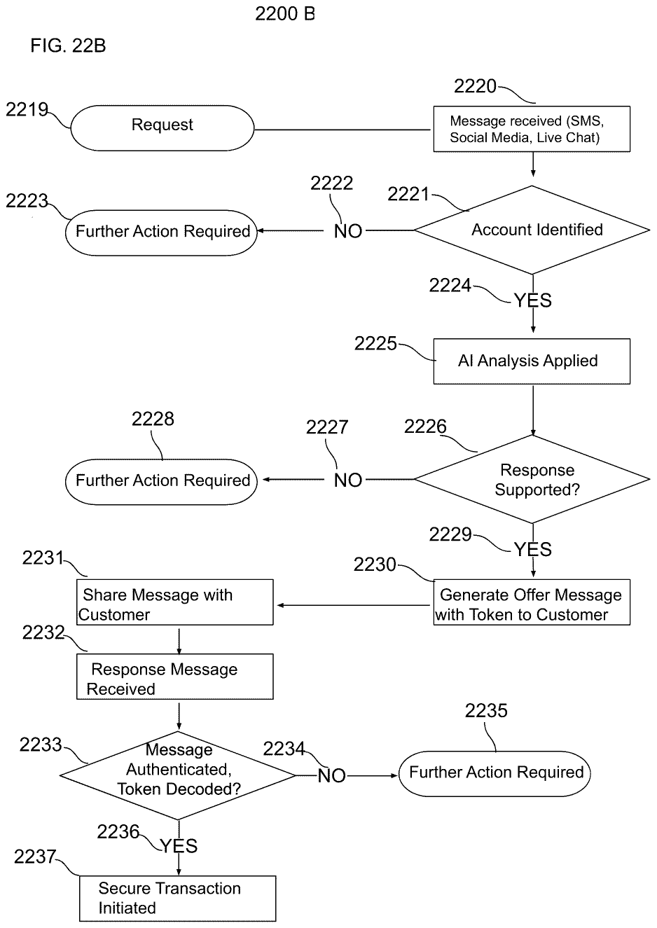

The core unit 149 of the authentication system 140 utilizes a WebSocket connection and broadcast (814) the subscription details to the browser unit of the customer device 1 150 granting secure access to the customer (815). The customer may be presented with a series of selections or options on the browser screen. FIG. 11 is an example of a secure account page 1100. The customer having accessed a secure channel, makes a selection at the browser unit. This may be achieved by a WebSocket connection. These selections may be a choice of many possible options for example credit card selection, an amount change or deliver instructions, these serve as an example only. The customer device 1 150 may exchange a series of requests (816) with the authentication system 140. The series of exchanges may also update the series of items to be purchased in a checkout. These exchanges may utilize the process described in FIG. 22A utilizing AI/Machine Learning 182 at step 2207. In this sample there is only one request shared with the API unit of the authentication system 140 but multiple exchanges are possible.

The implementation of AI/Machine Learning (AI/ML) in the system begins with the collection and preparation of diverse datasets. These include customer transaction records, email metadata, digital fingerprints, and biometric inputs, ensuring a comprehensive foundation for analysis. Preprocessing techniques such as data cleaning, normalization, and feature extraction are employed to enhance the quality of the data. Historical behavioral patterns and transaction logs are also analyzed to establish baselines, enabling the system to detect anomalies effectively. This stage ensures that the system operates on well-structured data, a crucial prerequisite for robust model performance.

Once the data is prepared, appropriate machine learning algorithms are selected to perform specific tasks. Supervised learning is used for classification tasks like distinguishing between authentic and spoofed emails, leveraging labeled datasets for training. Unsupervised learning methods are applied to identify anomalies in user behavior, such as unusual login patterns or outlier transactions. In adaptive systems, reinforcement learning plays a key role, refining decision-making strategies in real-time. These models undergo rigorous training using techniques like cross-validation and hyperparameter optimization to achieve high accuracy, precision, and recall.

Natural Language Processing (NLP) techniques further enhance the system's capabilities by enabling it to analyze unstructured data like email content and customer-written instructions. Tokenization and parsing help the system break down messages into meaningful components, while sentiment and intent analysis allow it to understand user requests. For example, NLP models can accurately interpret instructions for account updates or secure payments, ensuring seamless interaction between the customer and the system. This ability to comprehend natural language inputs improves user experience and bolsters the system's versatility.

Finally, the trained AI/ML models are integrated into the system's infrastructure for real-time data analysis and decision-making. By continuously monitoring live data streams, the system authenticates transactions, detects anomalies, and flags suspicious activities. Over time, it adapts to new threats and emerging patterns by learning from updated data and customer feedback. This adaptive capability ensures that the system remains robust and effective in dynamic environments. Additionally, the AI/ML-driven customer interactions—through secure notifications, dynamic interfaces, and authentication options—create a feedback loop that further refines the algorithms. Together, these elements deliver a secure, efficient, and user-friendly solution for authentication and transaction processing.

The API unit of authentication system 140 processes the payment (817) and sends (818) a notification to the customer device. Although in this example payment processing is an example only. Various secure transactions may be granted. A secure transaction may be access to a secure server, secure website, payment processing, control of a digital currency, record keeping, securities and/or contracts. Alternatively, a secure transaction may be granted to either the vendor, third-party or the customer. SMS messages or social media posts may be substituted for email messaging. SMS social media Unit 158 may substitute for Email client 156 and SMS social media Unit 188 may substitute for email client 186. Secure transactions may be blockchain secured by security module 162.

The described system can be implemented using blockchain to ensure enhanced data security, integrity, and transparency. Blockchain's decentralized and immutable nature makes it ideal for recording critical system data, such as authentication logs, transaction records, and anomaly detections. Each interaction or transaction within the system can be securely stored as a block in the chain, cryptographically linked to the previous block. This design ensures that records are tamper-proof and resistant to unauthorized modifications, providing a reliable foundation for data integrity and trust. Additionally, decentralized storage eliminates the risks associated with central points of failure, further bolstering the system's security.

By employing a blockchain-based decentralized identity framework, the system can store users' credentials, such as biometric templates or cryptographic keys, in an encrypted form on the blockchain. This approach allows users to maintain control over their data using private keys, ensuring that sensitive information remains inaccessible to unauthorized parties. Smart contracts can automate authentication processes by validating credentials and user actions without intermediaries, enhancing privacy while reducing operational complexity. These smart contracts can also facilitate automatic anomaly detection, flagging suspicious activities or halting unauthorized transactions in real-time, all while maintaining consistency and reliability in decision-making processes.

Blockchain also offers transparent and auditable records, making it ideal for compliance, fraud prevention, and dispute resolution. Every action recorded on the blockchain is time-stamped and immutable, ensuring a trustworthy audit trail for stakeholders to review and verify. This transparency extends to multi-party collaboration, where private or consortium blockchains can enable secure, unified interaction between organizations, such as banks or payment processors. By facilitating secure data sharing through encrypted channels, the system achieves interoperability without compromising privacy. Integrating blockchain into the described system not only strengthens security but also builds operational resilience and fosters user trust.

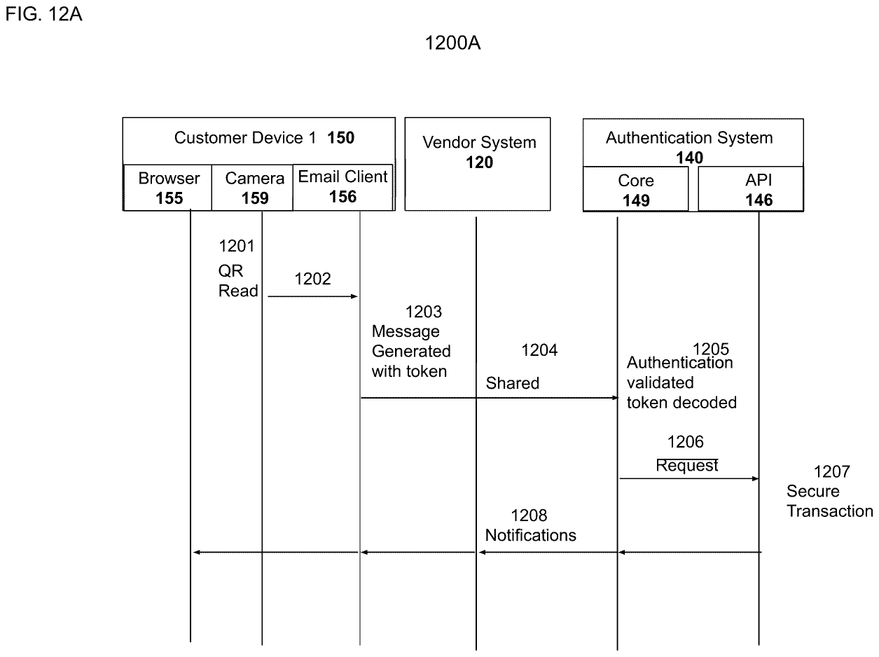

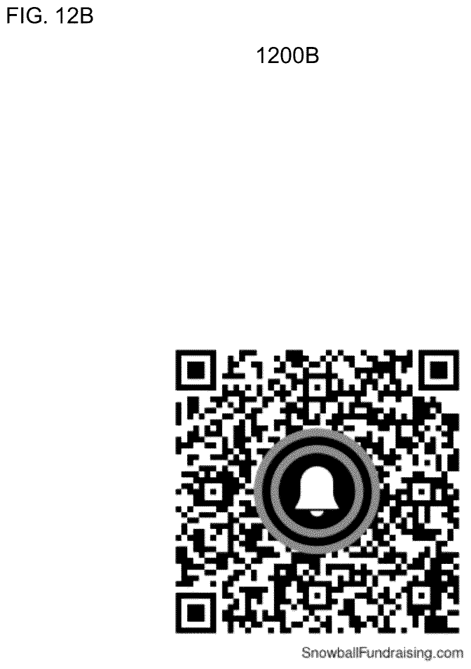

FIG. 12A is a diagram illustrating method 1200A describes the flow of transactions between the authentication system 140, the vendor 120 and customer device 1 150 using a quick response code to initiate an email for granting a secure transaction without a password. The disclosed invention allows the customer to access a secure transaction without a password by utilizing a unique email authentication method with a QR code. The authentication system 140 may generate mailto links, QR Codes and tokens for the purpose of granting secure transactions without a password. URLs that generate email messages may be substituted for mailto links. The token may contain transaction detail, security keys or secret pins. The authentication of an email message may serve as sufficient proof of customer identity. The QR code may be displayed in any manner, this may include a printed graphic, projected image, video display, television broadcast, smartphone, tablet or computer terminal. FIG. 12B is an example of a Quick Response code that may be used 1200B. This may be substituted for other formats such as bar codes or other image recognition formats. The camera unit 159 of the customer device 150 reads the QR code (1201) associated with a secure translation offered by the vendor system 120 and facilitated by the authentication system 140. It may be a request to make a payment, a reservation, a pledge, account registration, access to a secure server, request for a quote or may be a shopping cart function. The camera unit 159 of customer device scans the QR (1202) and triggers the email client of the customer device to generate an email message addressed to the authentication system (1203). FIG. 10 is an example email message 1000 used for authentication of the transaction. The email contains a token. Alternatively the scanning of the QR code may occur on an application with QR or equivalent imaging functionality. The mailto link with the token may be directly encoded in the QR code or may be accessed by an HTTP link, short url or other equivalent form of link.

The email message may contain the token. The token may be anywhere in the email. The token may be integrated into the email address (1003). Alternatively, the email address of the customer may serve as the identifier. The customer may select ‘send’ to transmit (1204) the message to the authentication system 140 core unit 149. Alternatively the message may be sent automatically. The authentication system 140 receives the email message.

The core unit 149 at the authentication system 140 performs a series of checks and authentication. The authentication system 140 authenticates the email using the digital signature (1205). These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes a fidelity algorithm to monitor changes to the collected data described in FIG. 24. 5) Artificial Intelligence checks may be employed as described in FIG. 23. 6) Biometric confirmation is confirmed as described in FIGS. 25 and 26.

If the message is determined to be not secure additional confirmations may be sent to the customer and alerts sent to the vendor and/or domains. The authentication system 140 may validate and authenticate the message to determine if the message is secure. Authentication may be limited to DKIM, DMARC or SPF path-base authentication. Only one form of authentication may be required. The authentication system 140 authenticates the digital signature in the customer email.

The authentication system 140 may decode the token. If the message is determined to be secure and authenticated (step 1205), The authentication system 140 may determine that all requirements are met and may perform the secure transaction. The core unit 149 of the authentication system 140 submits a request for a secure transaction to the API unit 146 of the authentication system (step 1206). In response the API unit 146 of the authentication system initiates the secure transaction (step 1207) and the transaction proceeds.

The API unit 146 of authentication system 140 sends (1208) a notification to the customer device and vendor. Various secure transactions may be granted. These exchanges may utilize the process described in FIG. 22A utilizing AI/Machine Learning 182 at step 2202. SMS messages or social media posts may be substituted for email messaging. SMS social media Unit 158 may substitute for Email client 156 and SMS social media Unit 188 may substitute for email client 186. Secure transactions may be blockchain secured by security module 162. A secure transaction may be access to a secure server, secure website, payment processing, control of a digital currency, record keeping, securities and/or contracts, pledges, donations and user registration. Alternatively, a secure transaction may be granted to either the vendor, third-party or the customer.

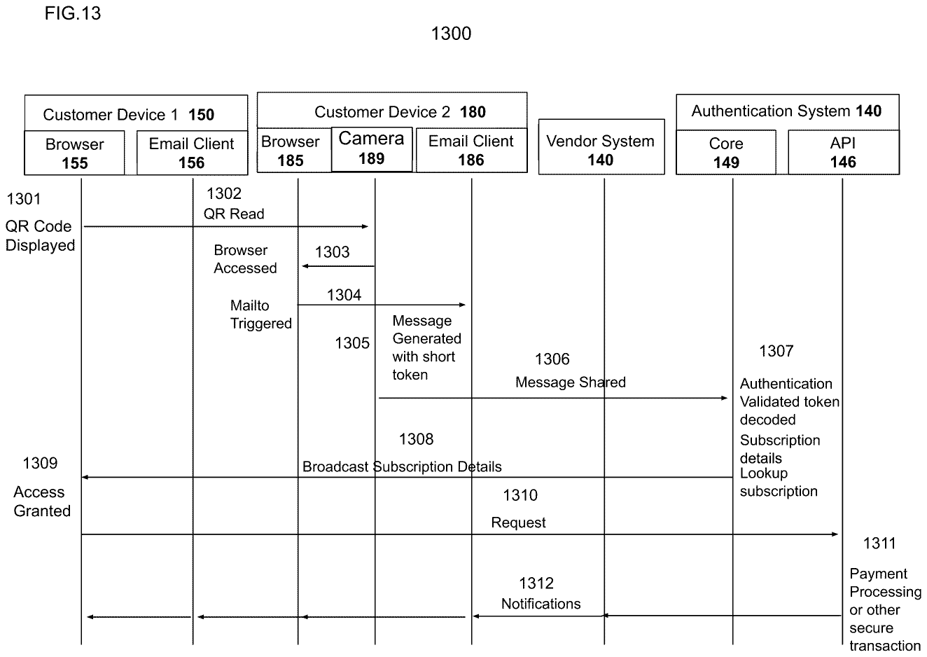

FIG. 13 is a diagram illustrating method 1300 for secure transactions utilizing multiple customer devices for increased security. Described is the flow of transactions between the authentication system 140, the vendor 120, customer device 1 150 and the customer device 2 180 for granting a secure transaction using Quick Response codes and email without a password. The disclosed invention allows the customer to access a secure connection without a password by utilizing a unique email authentication method with a QR code and then maintain a secure channel that enables updates via the customer's browser unit. The authentication system 140 may generate mailto links, QR Codes and tokens for the purpose of granting secure transactions without a password. URLs that generate email messages may be substituted for mailto links. The token may contain transaction detail, security keys or secret pins. The authentication of an email message serves as sufficient proof of customer identity. The browser unit 155 of the customer device 1 150 accesses a web page that displays a QR code (1301) associated with a secure translation offered by the vendor system 120. This page graphically may appear to the customer as the vendor website but is hosted by the authentication system 140. The page may offer the customer any one of several types of requests. FIG. 15 is an example of a webpage displaying the QR code. It may be a request to make a payment, a reservation, a pledge, account registration, access to a secure server, request for a quote or may be a shopping cart function. In this example, the customer requests access to a secure server and the authentication system 140 establishes a subscription for the transaction and generates a mailto link and token with an associated QR code at the API unit 146. The token may contain the subscription details. Alternatively the customer may choose a different type of secure transaction other than a payment such as making a payment. The camera unit 189 of customer device 2 180 scans the QR code (1302) displayed on the browser unit 155 of customer device 1 150 and triggers the link (1303) that accesses the browser 185 unit of customer device 2 180. Alternatively the scanning of the QR code may occur on an application with QR or equivalent imaging functionality. The mailto link with the token may be directly encoded in the QR code or may be accessed by an HTTP link, short url or other equivalent form of link. The customer device 2 180 browser unit 185 triggers the mailto link (1304). The mail client 186 of the customer device 2 180 and generates an email message addressed to the authentication system 140 (1305). FIG. 10 is an example email message 1000 used for authentication of the transaction.

The email message may contain the token and subscription. The token may be anywhere in the email. The token may be integrated into the email address (1003). Alternatively, the email address of the customer may serve as the identifier. The customer may select ‘send’ to transmit (1306) the message to the authentication system 140 core unit 149. Alternatively the message may be sent automatically. The authentication system 140 receives the email message.

The core unit 149 at the authentication system 140 performs a series of checks and authentication (1307). The authentication system 140 authenticates the email using the digital signature. These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes a fidelity algorithm to monitor changes to the collected data described in FIG. 24. 5) Artificial Intelligence checks may be employed as described in FIG. 23. 6) Biometric confirmation is confirmed as described in FIGS. 25 and 26.

If the message is determined to be not secure additional confirmations may be sent to the customer and alerts sent to the vendor and/or domains. The authentication system 140 may validate and authenticate the message to determine if the message is secure. Authentication may be limited to DKIM, DMARC or SPF path-base authentication. Only one form of authentication may be required. The authentication system 140 authenticates the digital signature in the customer email.

The authentication system 140 may decode the token and perform a lookup with the subscription details. If the message is determined to be secure and authenticated, the transaction proceeds and the authentication system 140 looks up the subscription (1307). The authentication system 140 may determine that all requirements are met and may perform the secure transaction at this point, for example to process the payment. Alternatively or additionally the authentication system 140 may publish a “pledge”, as a customer's intention to make a payment. The published pledge may be a publicly visible advertisement. (Not depicted)

The core 149 of the authentication system 140 utilizes a WebSocket connection and broadcast (1308) the subscription details to the browser unit of the customer device 1 150. The customer may be presented with a series of selections or options on the browser screen. The customer, having accessed a secure channel (1309), makes a selection at the browser unit. FIG. 11 is an example of a secure account page 1100. This may be achieved by a WebSocket connection. These selections may be a choice of many possible options for example credit card selection, an amount change or deliver instructions, these serve as an example only. The customer device 1 150 may exchange a series of requests (1310) with the authentication system 140. The series of exchanges may also update the series of items to be purchased in a checkout. These exchanges may utilize the process described in FIG. 22A utilizing AI/Machine Learning 182 at step 2207. In this sample there is only one request shared with the API unit 146 of the authentication system 140 but multiple exchanges are possible.

The API unit 146 of authentication system 140 processes the payment (1311) and sends (1312) a notification to the customer device. Although in this example payment processing is an example only. Various secure transactions may be granted. A secure transaction could be access to a secure server, secure website, payment processing, control of a digital currency, record keeping, securities and/or contracts. Alternatively, a secure transaction may be granted to either the vendor, third-party or the customer. SMS messages or social media posts may be substituted for email messaging. SMS social media Unit 158 may substitute for Email client 156 and SMS social media Unit 188 may substitute for email client 186. Secure transactions may be blockchain secured by security module 162.

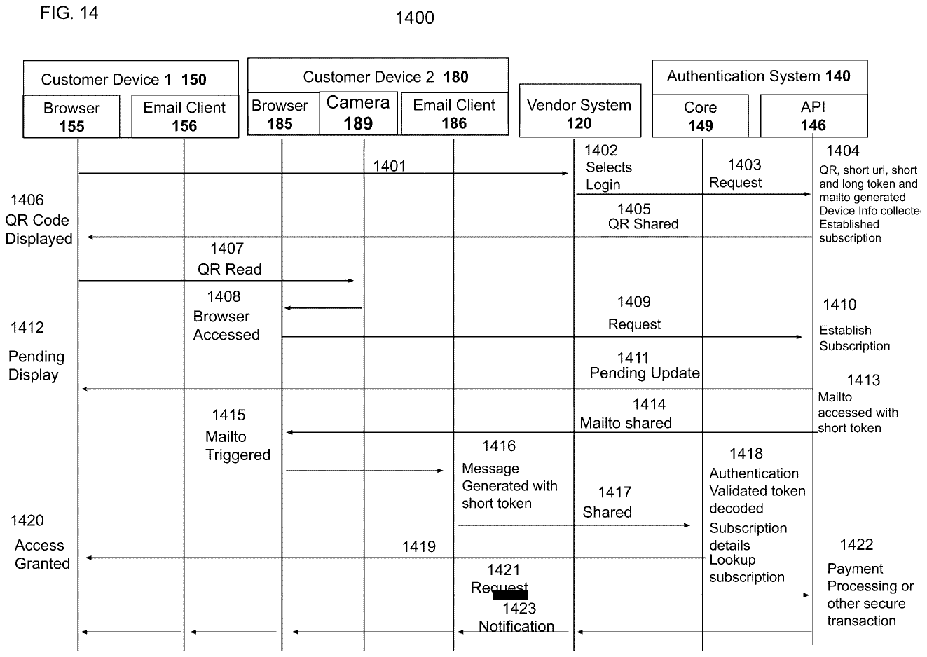

FIG. 14 is a diagram illustrating method 1400 for granting secure transactions using multiple devices without a password. Described is the flow of transactions between the authentication system 140, the vendor 120, customer device 1 150 and the customer device 2 180 for granting a secure transactions using email with WebSockets without a password. The disclosed invention allows the customer to access a secure connection without a password by utilizing a unique email authentication method with a QR code and then maintain a secure channel that enables updates via the customer's browser unit. The authentication system 140 may generate mailto links, QR Codes and tokens for the purpose of granting secure transactions without a password. URLs that generate email messages may substituted for mailto links. The token may contain transaction detail, security keys or secret pins. The authentication of an email message serves as sufficient proof of customer identity. The browser unit 155 of the customer device 1 150 accesses (1401) a web page of the vendor system 120. The customer selects the login option (1402) at the vendor system 120 accesses the authentication system 140 (1403). This page graphically may appear to the customer as the vendor website but is hosted by the authentication system 140. The page may offer the customer any one of several types of requests. It may be a request to make a payment, a reservation, a pledge, account registration, access to a secure server, request for a quote or may be a shopping cart function. In this example, the customer requests access to a secure server and the authentication system 140 establishes a subscription for the transaction and generates a mailto link and token with an associated QR code at the API unit (1404). The token may contain the subscription details. Alternatively the customer may choose a different type of secure transaction other than a payment such as making a payment. The authentication system 140 shares a QR code with the browser unit 155 of the customer device 1 150 (1405). The QR code is displayed on the screen of the customer device 1 150 (1406). FIG. 15 is an example of a webpage displaying the QR code. The camera unit 189 of customer device 2 180 scans the QR code (1407) and triggers the short url that accesses the browser unit 185 of customer device 2 180 (1408). Alternatively the scanning of the QR code may occur on an application with QR or equivalent imaging functionality. Customer device 2 180 shares a request to the authentication system 140 for the subscription and mailto link (1409). The authentication unit established the subscription (1410). The authentication system 140 shares a pending status with the browser unit 155 of the customer device 1 150 (1411). The browser unit 155 may display a graphic alerting the customer to the pending status (1412). This graphic may include instructions for customer device 2 180. The authentication system 140 accesses the short token and mailto link (1413). The authentication unit 140 shares (1414) the mailto login link that includes a short token and subscription with the browser unit 185 of the customer device 2 150. The customer device 2 180 browser unit 185 triggers the mailto link (1415). The mail client 186 of the customer device 2 180 generates an email message addressed to the authentication system 140 (1416).

The email message may contain the token and subscription. The token may be anywhere in the email. FIG. 10 is an example email message 1000 used for authentication of the transaction. The token may be integrated into the email address (1003). Alternatively, the email address of the customer may serve as the identifier. The email client 186 of customer device 180 may select ‘send’ to transmit (1417) the message to the authentication system 140 core unit 149. Alternatively the message may be sent automatically. The authentication system 140 receives the email message.

The core unit 149 at the authentication system 140 performs a series of checks and authentication (1418). The authentication system 140 authenticates the email using the digital signature. These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes a fidelity algorithm to monitor changes to the collected data described in FIG. 24. 5) Artificial Intelligence checks may be employed as described in FIG. 23. 6) Biometric confirmation is confirmed as described in FIGS. 25 and 26.

If the message is determined to be not secure additional confirmations may be sent to the customer and alerts sent to the vendor and/or domains. The authentication system 140 may validate and authenticate the message. If the message is determined to be secure and authenticated, the short token is matched with the long token and the long token is decoded. (1418) Authentication may be limited to DKIM, DMARC or SPF path-base authentication. Only one form of authentication may be required. The authentication system 140 authenticates the digital signature in the customer email. The long token may contain the subscription.

The authentication system 140 may decode the token and perform a lookup with the subscription details. If the message is determined to be secure and authenticated, the transaction proceeds and the authentication system 140 looks up the subscription. The authentication system 140 may determine that all requirements are met and may perform the secure transaction at this point, for example to process the payment. Alternatively or additionally the authentication system 140 may publish a “pledge”, as a customer's intention to make a payment. The published pledge maybe be a publicly visible advertisement. (Not depicted)

The core of the authentication system 140 utilizes a WebSocket connection and broadcast (1419) the subscription details to the browser unit 155 of the customer device 1 150. The customer may be presented with a series of selections or options on the browser screen. The customer, having accessed a secure channel (1420), makes a selection at the browser unit. This may be achieved by a WebSocket connection. FIG. 11 is an example of a secure account page 1100. These selections may be a choice of many possible options for example credit card selection, an amount change or deliver instructions, these serve as an example only. The customer device 1 150 may exchange a series of requests (1421) with the authentication system 140. The series of exchanges may also update the series of items to be purchased in a checkout. These exchanges may utilize the process described In FIG. 22A utilizing AI/Machine Learning 182 at step 2207. In this sample there is only one request shared with the API unit 146 of the authentication system 140 but multiple exchanges are possible.

The 140 API unit 146 of authentication system 140 a secure transaction is confirmed and the customer is granted secure access to a server (1422) and sends (1423) a notification to the customer device. Although in this example of secure sign in it is an example only. Various secure transactions may be granted. A secure transaction may be access to a secure server, secure website, payment processing, control of a digital currency, record keeping, securities and/or contracts. Alternatively, a secure transaction may be granted to either the vendor, third-party or the customer. SMS messages or social media posts may be substituted for email messaging. SMS social media Unit 158 may substitute for Email client 156 and SMS social media Unit 188 may substitute for email client 186. Secure transactions may be blockchain secured by security module 162.

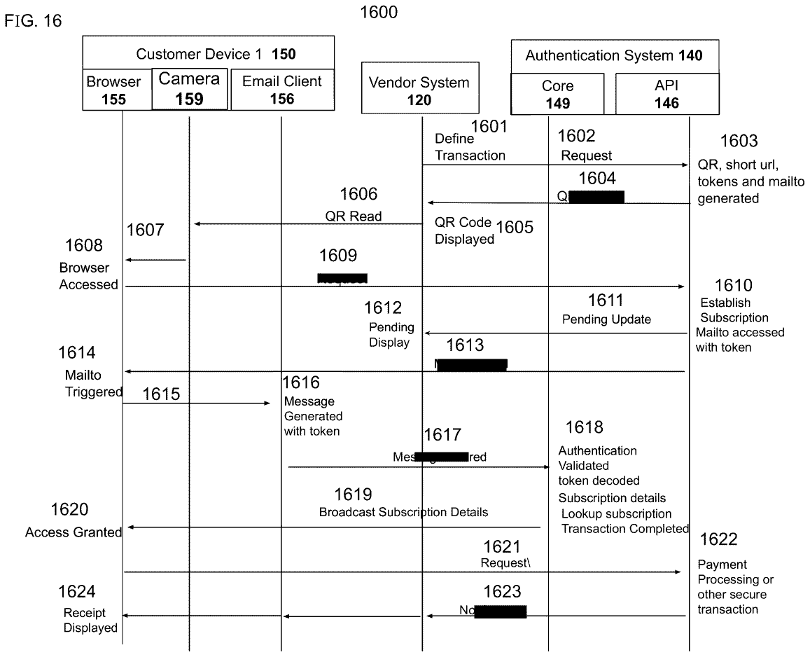

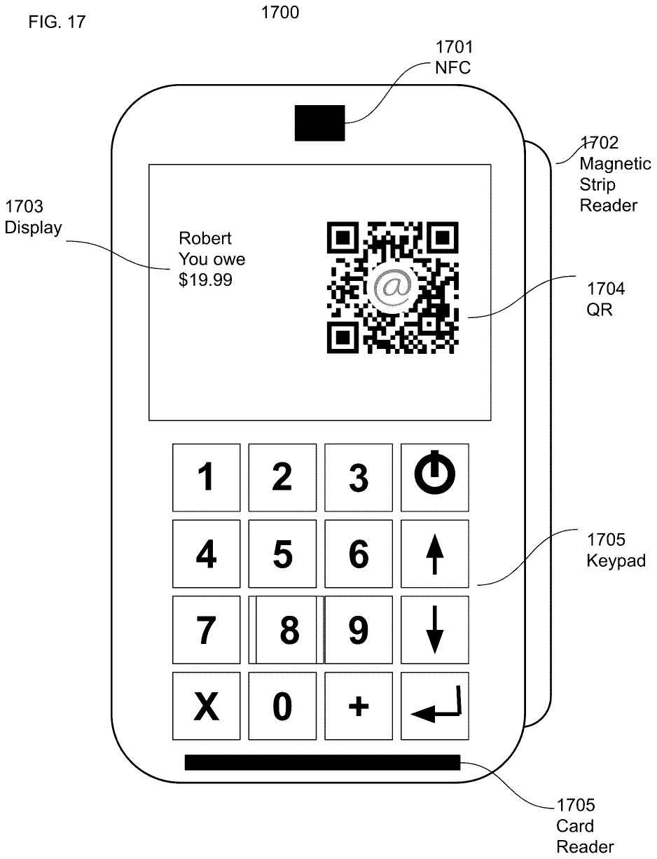

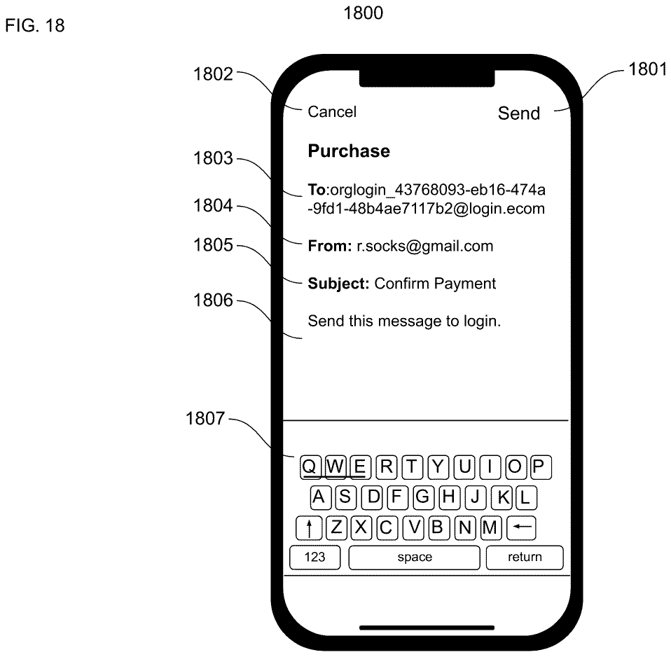

FIG. 16 is a diagram illustrating the flow of in-store transactions between the authentication system 140, the vendor 120 and customer device 150 for granting a secure transactions using email with websockets without a password. The disclosed invention allows the customer to access a secure connection without a password by utilizing a unique email authentication method with a QR code and then maintain a secure channel that enables updates via the customer's browser unit 155. The vendor system 120 may generate an invoice at an in-person cashier, payment terminal in a brick and mortar location such as a market or restaurant. The vendor system 120 may generate an invoice and access the authentication system using a computer, a smartphone or mobile cashier device depicted in FIG. 17. The authentication system 140 may generate mailto links, QR Codes and tokens for the purpose of granting secure transactions without a password. URLs that generate email messages may substituted for mailto links. The token may contain transaction detail, security keys or secret pins. The authentication of an email message serves as sufficient proof of customer identity. The vendor at the vendor system 120 defines the transaction (1601). In this case it is a request for a payment of an invoice. The vendor system 120 accesses the authentication system 140 API unit 146 (1602). The invoice may be generated on a device controlled by the vendor system 120 or maybe generated by the authentication system 140 as part of the request. It may be a request to make a payment, a reservation, account registration, access to a secure server, request for a quote or may be a shopping cart function. In this example, the customer requests access to a secure server to make a payment and the authentication system 140 generates a mailto link, short url and token with an associated QR code at the API unit 146 (1603). The token may contain the subscription details. Alternatively the customer may choose a different type of secure transaction other than a payment such as making a payment. The authentication system 140 shares a QR code with the vendor system 120 (1604). The QR code may be displayed (1605) on a display of a mobile phone, cashier device (1704), digital projection, printed graphic or other imaging format The camera unit 159 of the customer device 1 150 scans the QR code (1606) and triggers the short url (1607) that accesses the browser unit of the customer device (1608). Customer device 1 150 shares a request to the authentication system 140 for the subscription and mailto link (1609). The authentication system 140 establishes a subscription for the transaction and generates a mailto link (1610). The authentication system 140 shares a pending status with the browser unit of the vendor system 120 (1611). The pending status of the transaction is displayed at the vendor system 120 (1612). The authentication system shares 140 shares the mailto login link that includes a short token and subscription with the browser unit of the customer device 1 150 (1613). The customer device 1 150 browser unit 155 triggers the mailto link (1614) that activates the email client 156 of the customer device 1 150 (1615) and generates an email message addressed to the authentication system 140 (1616). FIG. 18 is an example of the email message request for a secure transaction method 1800.

The email message may contain the token and subscription. The token may be anywhere in the email. The token may be integrated into the email address (1903). Alternatively, the email address of the customer may serve as the identifier. The customer may select ‘send’ (1901) to transmit (1617) the message to the authentication system 140 core unit. Alternatively the message may be sent automatically. The authentication system 140 receives the email message.

The core unit 149 at the authentication system 140 performs a series of checks and authentication (1618). The authentication system 140 authenticates the email using the digital signature. These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes a fidelity algorithm to monitor changes to the collected data described in FIG. 24. 5) Artificial Intelligence checks may be employed as described in FIG. 23. 6) Biometric confirmation is confirmed as described in FIGS. 25 and 26.

If the message is determined to be not secure additional confirmations may be sent to the customer and alerts sent to the vendor and/or domains. The authentication system 140 may validate and authenticate the message. If the message is determined to be secure and authenticated, the short token is matched with the long token and the long token is decoded. Authentication may be limited to DKIM, DMARC or SPF path-base authentication. Only one form of authentication may be required. The authentication system 140 authenticates the digital signature in the customer email. The long token may contain the subscription.

The authentication system 140 may decode the token and perform a lookup with the subscription details. If the message is determined to be secure and authenticated, the transaction proceeds and the authentication system 140 looks up the subscription. The authentication system 140 may determine that all requirements are met (1618) and may perform the secure transaction at this point, for example to process the payment. Alternatively or additionally the authentication system 140 may publish a “pledge”, as a customer's intention to make a payment. The published pledge maybe be a publicly visible advertisement. (Not depicted)

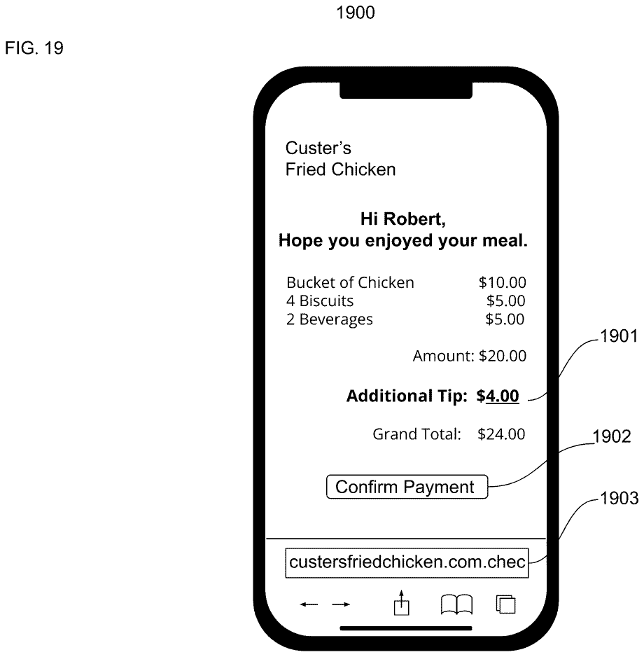

The core of the authentication system 140 utilizes a WebSocket connection and broadcast (1619) the subscription details to the browser unit 155 of the customer device 150. The customer may be presented with a series of selections or options on the browser screen. In this example the customer is presented with an invoice for a meal. FIG. 19 is an example of the display of the invoice in the illustration 1900 of a customer device having accessed a secure channel. The customer views the items and the amount due and has the option to add a gratuity (1901) and which is added to the grand total in an automated fashion. The customer, having accessed a secure channel (1620), makes a selection at the browser unit. This may be achieved by a WebSocket connection. These selections may be a choice of many possible options for example credit card selection, an amount change or deliver instructions, these serve as an example only. The customer device 1 150 may exchange a series of requests (1621) with the authentication system 140. The series of exchanges may also update the series of items to be purchased in a checkout. These exchanges may utilize the process described in FIG. 22A utilizing AI/Machine Learning 182 at step 2207. In this sample there is only one request shared with the API unit 146 of the authentication system 140 but multiple exchanges are possible.

The API unit of authentication system 140 processes the payment (1622) and sends (1623) a notification to the customer device 1. This notification may include a receipt of the secure transaction (1624). This notification may include an update to the vendor system 120 to alert the vendor that the transaction is complete and no longer pending. Although in this example payment processing is an example only. Various secure transactions may be granted. A secure transaction may be access to a secure server, secure website, payment processing, control of a digital currency, record keeping, securities and/or contracts. Alternatively, a secure transaction may be granted to either the vendor, third-party or the customer. SMS messages or social media posts may be substituted for email messaging. SMS social media Unit 158 may substitute for Email client 156 and SMS social media Unit 188 may substitute for email client 186. Secure transactions may be blockchain secured by security module 162.

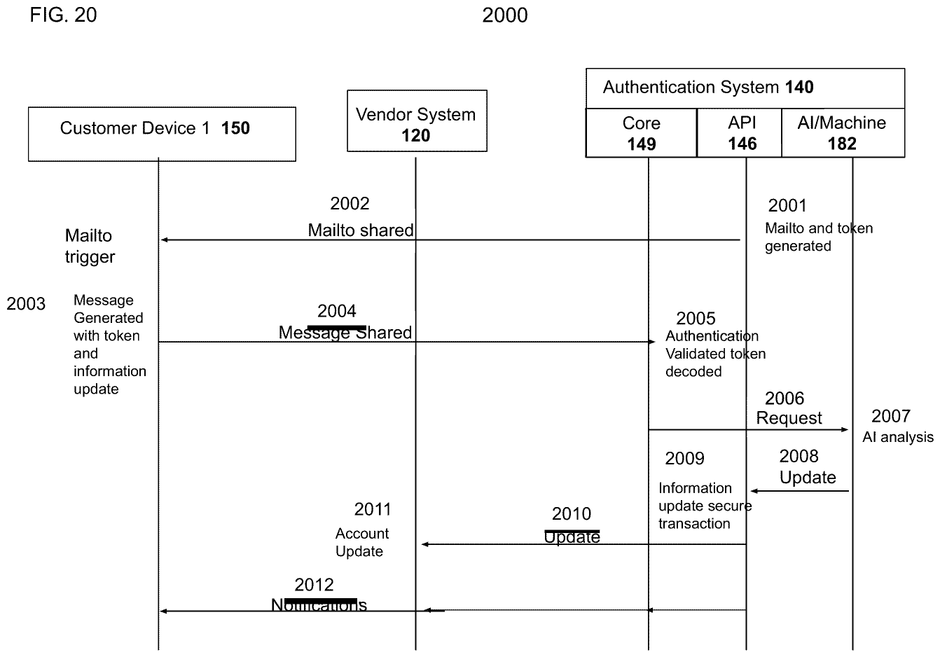

FIG. 20 is a transactional flow diagram 2000 illustrating the process of a customer updating a secure account without the use of a password using artificial intelligence/Machine Learning. Disclosed is a process where the authentication system authenticates, validates, decodes tokens and evaluates the fields of email messages. Based on the evaluation, the authentication system 140 may take various actions in response and update a customer's secure account without the customer accessing the account directly.

The invention employs Artificial Intelligence (AI) and Machine Learning (ML) to streamline and secure the process of account updates by automating complex workflows, analyzing user data, and providing adaptive responses based on real-time and historical insights. When a user sends an email request to update their account—such as modifying contact details, changing a password, payment methods, or account preferences, the AI/ML mode identifies the request based on the text input into the body of the email.

The AI/ML models then validate and process the input by cross-referencing it with historical account activity, external data sources (e.g., credit agencies or public records), and predictive algorithms to ensure accuracy and detect inconsistencies. For example, when a user updates a payment method, the system checks for valid card credentials, cross-verifies billing addresses with previously stored data, and flags potential mismatches. The AI models analyze patterns in user behavior to predict potential errors, such as identifying common typos in names or addresses, and either correcting them automatically or prompting the user for confirmation. In cases of sensitive updates, like a change in account ownership, the system may require additional data input, such as biometric authentication or multi-factor verification, further securing the process.

Over time, the system refines its models by learning from user interactions and historical data, improving its ability to process updates swiftly, predict common modifications, and enhance security measures against fraudulent activities. This combination of intelligent data processing and user-centric design ensures an efficient, accurate, and secure mechanism for account updates.

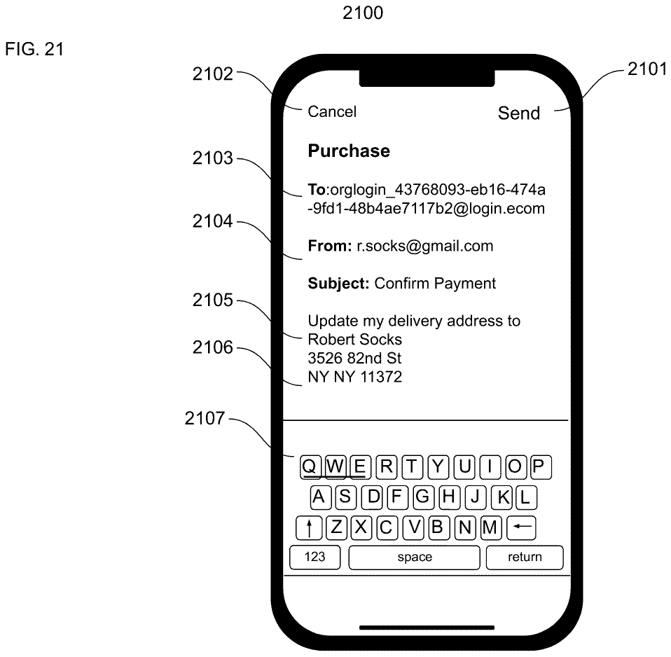

As shown in FIG. 20, the AI/Machine Learning Unit 182 may be hosted by the authentication system 140 or by a third party. The API 146 of the authentication system 140 generates a mailto link with at least one identifier at step 2001. URLs that generate email messages may substituted for mailto links. The authentication system 140 shares the mailto link with the customer device 1 150 at step 2002. The transmission of the mailto link and identifier may be include but not limited to a web browser, email message, SMS or social media message or NFC or QR code. The customer device 1 150 accesses the mailto link and at step 2003 and requests a secure transaction, sign in, login or payment option. The selection of the mailto link generates an email response message addressed with at least one identifier to the authentication system 140. FIG. 21 is an example of an email response message. The identifier could be anywhere in the message. The identifier/token maybe integrated into the email address 2103. Alternatively, the email address of the customer may serve as the identifier. The customer may write instructions in a field of the email message. In this example it is an instruction to update delivery instructions 2105. These instructions may be in a form or include an attached file. The attachment may be an audio file, voice command, image or programmatic data. The customer device 150 shares the email message and identifier and the information update with the core unit 149 of authentication system 140 at step 2104. The core unit 149 of the authentication system 140 receives the email from the customer device 1 150 and authenticates the message at step 2005.

Various forms of authentication may be used such as SPF, DKIM and DMarc. Authentication may be limited to DKIM, DMarc or SPF path-based authentication. The authentication system 140 authenticates the customer email using the digital signature. The authentication system 140 may take one or more actions based on the outcome of the authentication process. The authentication system 140 may perform a look up of the customer's account using the identifier and or email address. The authentication system 140 decodes the identifier/token. The authentication system 140 may not require any identifier. If the customer is not authenticated or is missing information or does not have an account, the customer may be navigated to a signup page for registration with the vendor 120 and the authentication system 140. If all requirements are met, The core unit 149 of the authentication system 140 performs an analysis of the fields of the email and determines that an update is required. In this example, a delivery address requires an update in the customer's account. The core unit 149 of the authentication system determines an update has occurred and submits the field data to the AI/Machine Learning Unit 182 step 2006. AI/Machine Learning Unit 182 interprets the updated field and determines the action requested step 2007. AI/Machine Learning Unit 182 interpretation may include any attachment included in the message such as a voice command. The I/Machine Learning Unit 182 of the authentication system 140 shares the update with the API 146 at step 2008. The API 146 initiates a secure transaction on behalf of the customer and updates the customer's account at step 2009. This may include updating a secure server in the authentication system or sending an update to the vendor system 120 based on the artificial intelligence analysis and successful authentication of the email and decoding of the identifier and shares the identifier with the vendor system 120 at step 2010. The vendor system 120 may update customer information at step 2011. The authentication system 140 may send notifications to the vendor system 120 and the customer device 150 updating them on the status of the customer device request at step 2012. The notification message may contain a response to the update or may contain an attachment generated by the result of the artificial intelligence analysis. Although in this example interpreting a written request for granting access for delivery address update to a secure server is described it is an example only. Various written requests for secure transactions may be granted. A secure transaction may be access to a secure server, secure website, payment processing, control of a digital currency, record keeping, securities and/or contracts. The process of granting access to a customer may allow access to more than one account and more than one customer. It may consist of interpreting an attached file or giving instructions for an attachment. Alternatively the customer may utilize the authentication notification and grant access to a third party vendor. Alternatively or additional in some configurations additional factors of authentication may be applied as described in FIGS. 22A, 22B, 23, 24, 25 and 26. SMS messages or social media posts may be substituted for email messaging. SMS social media Unit 158 may substitute for email client 156 and SMS social media Unit 188 may substitute for email client 186. Secure transactions may be blockchain secured by security module 162.

FIG. 22A is a flow diagram 2200A illustrating the authentication system 140 analyzing email messages with artificial intelligence/machine learning to facilitate a secure transaction on the behalf of the customer. Disclosed is a process where the authentication system authenticates, validates, decodes tokens and evaluates the fields of messages. Based on the evaluation, the authentication system 140 may take various actions in response and update a customer's secure account without the customer accessing the account directly. One example may be autonomous shopping where offers are researched, customized, managed and acquired on behalf of the customer. This serves as an example only and may include actions on secure servers or servers publicly available. The AI/Machine Learning Unit 182 may be hosted by the authentication system 140 or by a third party.

For example, AI may be utilized to identify irregularities by analyzing large volumes of data in real-time and applying machine learning models to detect deviations from established patterns or norms. The AI system operates by first learning typical behaviors, trends, and transaction patterns associated with vendors, customers, or the system as a whole. This learning process involves training on historical data, such as transaction records, user interactions, and system performance metrics, to establish a baseline of expected activity.

Once the baseline is established, the AI monitors ongoing activities to identify anomalies. For instance, irregularities could include unusual transaction frequencies, unexpected changes in vendor or customer behavior, or suspicious alterations in inventory or pricing data. The system uses predictive algorithms and statistical analyses to flag these deviations, leveraging techniques like clustering, anomaly detection, and predictive modeling.

Additionally, the AI can continuously refine its ability to detect irregularities by incorporating feedback from flagged events. For example, if a flagged irregularity is verified as genuine, the AI adjusts its thresholds and models to better identify similar events in the future. By doing so, the AI not only ensures real-time detection but also adapts to evolving patterns, making it more robust and accurate in safeguarding the integrity and functionality of the system.

As shown in FIG. 22A, Flow diagram 2200A the customer device may submit a request to the authentication system at step 2201. The customer email message is authenticated, validated and token decoded (step 2202). The authentication system 140 determines the fields of the email have been updated (step 2203). Multiple fields may be checked for changes against previous versions. If the check provides a response of NO (step 2204), transactions may proceed (step 2205). If the check provides a response of YES (step 2206), the authentication system 140 determines that fields of the customer email message are different. If the check determines a change has occurred, designated by YES (step 2206), the authentication system 140 may submit the customer email message to artificial intelligence analysis. The AI/Machine Learning Unit 182 may access various resources to evaluate the email fields including the data collected on the customer's past requests, vendor information specific to the customer in addition to publicly available data (step 2207). The result of the The AI/Machine Learning Unit 182 analysis produces an interpretation that is compared to a selection of possible responses offered by the authentication system 140 and or vendor system 120 and the authentication system 140 determines if the response is supported (step 2208). The determination may require AI/Machine Learning Unit 182 to look up a series of automated responses from various units such as libraries 169, DB 163, purchase execution 142 and determine which analysis results may correspond to the automated responses. The look up may also be from the vendor or third party. If the response is not supported and provides a response of NO (step 2209), transactions may message the customer that further action is required (step 2210). If the response is supported and can be matched to a supported action and provides a response of YES (step 2211), the response is submitted as an update (step 2212). The update may be various actions such as making a payment. Alternatively it may be the composing of offers such as an itinerary for travel. Various secure transactions may be granted. A secure transaction may be access to a secure server, secure website, payment processing, control of a digital currency, record keeping, securities and/or contracts. Alternatively, a secure transaction may be granted to either the vendor, third-party or the customer. The authentication system 140 (step 2213) may make the update to the customer account as a secure transaction. The AI/Machine Learning Unit 182 determines if a message pertaining to the updated secure transaction is required (step 2213). If the update does not require a message and provides a response of NO (step 2217), the transaction may proceed and the secure transaction completed (step 2218). If a message is required and provides a response of YES (step 2214) the message update is generated by the authentication system (2215). For example, it may include generating a message that includes the proposed itinerary for travel. The authentication system 140 the message update is sent to the customer device (step 2216). The updated message may be a confirmation that requires a response. Various forms of messaging may be used such as email, SMS messages or social media posts. SMS social media Unit 158 may substitute for email client 156 and SMS social media Unit 188 may substitute for email client 186. Secure transactions may be blockchain secured by security module 162.

FIG. 22B is a flow diagram 2200 B illustrating the authentication system 140 analyzing a variety of messages with artificial intelligence/Machine learning and response and authenticating transactions using email. Disclosed is a process where the authentication system authenticates, validates, decodes tokens and evaluates the fields of email messages. Based on the evaluation, the authentication system 140 may take various actions in response and update a customer's secure account without the customer accessing the account directly. One example may be autonomous shopping where offers are researched, customized, managed and acquired on behalf of the customer. This serves as an example only and may include actions on secure servers or servers publicly available. The AI/Machine Learning Unit 182 may be hosted by the authentication system 140 or by a third party.

Flow diagram 2200 B the customer device 1 150 may submit a request to the authentication system at step 2219. This request may be in a variety of formats such as SMS message, social media or part of an automated live chat function. The customer message is received by the authentication system 140 (step 2220) and the customer account is identified at step 2221. For example with SMS the phone number may be used as a reference to the customer account. The registration status of the customer account may be checked. If the check provides a response of NO (step 2222), transactions may message the customer device 1 150 that further action is required (step 2223). If the check provides a response of YES (step 2224), transactions may proceed and the contents of the message may be submitted to AI/Machine 182 for analysis at (step 2225). The result of the The AI/Machine Learning Unit 182 analysis produces an interpretation that is compared to a selection of possible responses offered by the authentication system and or vendor system and the authentication system determines if the response is supported (step 2226). The AI/Machine 182 may mine the data history of the customer device 1 150 and any associated device and any vendors accounts associated with the customer account to make determinations, If the response is not supported and provides a response of NO (step 2227), transactions may message the customer device 1 150 that further action is required (step 2228). If the response is supported and may be matched to a supported action and provides a response of YES (step 2229), the authentication system 140 response generates an offer message to confirm the requested secure transaction that includes a token and mailto link (step 2230). The customer may be offered a series of possible options corresponding to separate mailto links. URLs that generate email messages may substituted for mailto links. The token may contain transaction detail, security keys or secret pins. The mailto may be presented to the customer through other means such as email, SMS, social media, web browser or live chat. The authentication system 140 shares the message with the customer (Step 2231). The authentication system 140 receives the response email from the customer (Step 2232).

The authentication system 140 performs a series of checks and authentication (2233). The authentication system 140 authenticates the email using the digital signature. These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes a fidelity algorithm to monitor changes to the collected data described in FIG. 24. 5) Artificial Intelligence checks may be employed as described in FIG. 23. 6) Biometric confirmation is confirmed as described in FIGS. 25 and 26.

If the message is not authenticated and validated and the tone not decoded and the check provides a response of NO (step 2234), transactions may message the customer that further action is required (step 2235). The transaction may be terminated. If the message is authenticated and validated and the token decoded and the check provides a response of YES (step 2235), the authentication system 140 initiates the secure transaction. The authentication of an email message serves as sufficient proof of customer identity. Various secure transactions may be granted. A secure transaction may be access to a secure server, secure website, payment processing, control of a digital currency, record keeping, securities and/or contracts. Alternatively, a secure transaction may be granted to either the vendor, third-party or the customer. Secure transactions may be blockchain secured by security module 162.

FIG. 23 is a flow diagram 2300 illustrating the authentication system utilizing an artificial intelligence machine learning data monitoring process for improved security. AI/Machine Learning Unit 182 data monitoring may compare data collected from multiple devices controlled by a customer to flag inconsistencies that may signal fraudulent activity by outside parties. This may be used with or as an alternative to cookies or IP Address. Disclosed is a process where the authentication system authenticates, validates, decodes tokens, collects device data to confirm customer identity. The authentication system may apply an artificial intelligence server AI/Machine Learning 182 to data collected from multiple devices controlled by the customer that are associated with the customer. For example, a desktop computer that displays a QR code that a smartphone scans. AI/Machine Learning 182 may confirm the location of both customer device 1 150 and customer device 2 180 to confirm that they are in the same vicinity using the geographical location pulled from each device. The authentication system 140 utilizes AI/Machine Learning 182 to correlate the required actions of the customer with corresponding data from the devices. Based on the evaluation, the authentication system 140 may take various actions in response. This serves as one example only. In evaluations that flag irregularities the transaction may be paused or canceled and the customer alerted or contacted for additional information.

The AI/ML system may analyze and interpret customer email messages, facilitating secure transactions and account updates efficiently and accurately. Initially, the system authenticates, validates, and decodes tokens from customer emails, allowing the AI/ML Unit to evaluate fields within the messages. By accessing historical customer data, vendor-specific information, and publicly available resources, the AI/ML system creates a comprehensive context for interpreting the email content. This enables it to identify patterns, detect changes in the email fields, and predict the email's intent with precision. Based on its analysis, the system maps the results to predefined responses or actions, such as making payments, generating travel itineraries, or granting access to secure servers or websites.

Once an action is determined, the system autonomously initiates secure transactions or updates customer accounts, leveraging blockchain technology where necessary to ensure robust security. If the system finds no suitable action, it notifies the customer for manual intervention, maintaining transparency and control. Additionally, the AI/ML system continuously learns from interactions with customers and vendors, improving its ability to process new types of requests over time. This iterative learning ensures adaptability and enhances the system's performance in predicting and executing actions.

The system also manages communication with customers by determining whether follow-up messages, such as confirmations or summaries, are required after a secure transaction or account update. If necessary, it generates customized notifications and delivers them through email, SMS, or social media platforms. By automating these processes, the AI/ML system minimizes the need for direct customer involvement while maintaining efficiency, accuracy, and security, streamlining the management of customer accounts and transactions.

As shown in FIG. 23, Flow 2300 the customer device 1 150 may submit a request to the authentication system 140 at step 2301. Various data points may be collected (step 3202) such as operating system, browser version, installed fonts and plugins, screen resolution, time zone, battery level, geographic location, MAC address, digital certificates, passkey, biometric and internet protocol (IP) address. The data may include email address and access data related to HTTP, SPF, DKIM and DNS results. A check for is performed to determine if AI/Machine Learning is required to continue the transaction (step 2303). If the check provides a response of NO (step 2304), the transaction is allowed to proceed (step 2305). If the check provides a response of YES (step 2306), the customer device history is accessed (step 2307). This may include identifying the user and accessing a library of past data collection such as library 169 and custom account information 124 and flagging variations or irregularities when compared to the request under evaluation. The data from the customer device 1 150 collected based on the request is compared to the device data history (step 2308). AI/Machine Learning 182 determines if there are irregularities. This may be done based on a preestablished threshold which must be reached. This threshold may be defined by the AI/Machine Learning 182 or by established criteria set by the authentication system 140, vendor system 120 or by the customer device 150. A check is performed to determine if the data is consistent (step 2309). If the check provides a response of NO (step 2310), may be paused or canceled and the customer alerted (step 2311). If the check provides a response of YES (step 2312), the transaction is allowed to proceed (step 2313). The transaction may proceed if no irregularities are found. This process may be integrated into the security process described in FIGS. 22A, 22B, 24, 25 and 26. SMS messages or social media posts may be substituted for email messaging. SMS social media Unit 158 may substitute for Email client 156 and SMS social media Unit 188 may substitute for email client 186. Secure transactions may be blockchain secured by security module 162.

FIG. 24 is a flow diagram 2400 illustrating the authentication system monitoring device data and email messages for improved security. Using multi-finger printing. The multi-fingerprint described in the invention refers to a composite identification mechanism that uses multiple unique identifiers or attributes to securely and accurately identify a vendor, customer, or transaction. Unlike a single identifier, such as a username or an account number, a multi-fingerprint comprises a combination of data points that collectively form a robust and unique identity signature. These data points can include elements like device identifiers, geolocation data, timestamps, transaction history, or biometric information.

This multi-fingerprint approach enhances security and accuracy by reducing the likelihood of fraud or error. For example, even if one identifier is compromised or falsified, the system cross-verifies the other components of the fingerprint to ensure authenticity. The multi-fingerprint is dynamic, meaning it can adapt and update based on real-time interactions or contextual data. For instance, a vendor's multi-fingerprint may include not just their unique identifier but also real-time information about their inventory, pricing, or recent transactions, creating a more comprehensive profile.

The invention leverages the multi-fingerprint in various ways, such as facilitating secure authentication, streamlining transactions, and enabling personalized interactions. By utilizing this composite identification mechanism, the system can reliably match vendors and customers, prevent unauthorized access, and support complex operations like dynamic display updates or adaptive recommendations. Overall, the multi-fingerprint is a cornerstone of the invention's ability to create a secure, efficient, and context-aware ecosystem.

Device data monitoring may compare data collected from multiple devices controlled by a customer to flag inconsistencies that may signal fraudulent activity by outside parties. This may be used with or as an alternative to cookies or IP Address. Disclosed is a process where the authentication system 140 authenticates, validates, decodes tokens, collects device data to confirm customer identity. The authentication system 140 may apply an algorithm to data collected from multiple customer devices (Customer Device 150 and 180) controlled by the customer that are in relationship and programmatically linked. For example, a desktop computer that displays a QR code that a smartphone scans. An algorithm may confirm the location of both the desktop computer and the smartphone to confirm that they are in the same vicinity using the geographical location pulled from each device. The authentication system 140 uses the algorithm to correlate the required actions required of the customer with corresponding data from the devices (Customer Device 150 and 180). Based on the evaluation, the authentication system 140 may take various actions in response. This serves as one example only. In evaluations that flag irregularities the transaction may be paused and the customer alerted or naked for additional information. The transaction may proceed if no irregularities are found.

Flow 2400 the customer device 1 150 may submit a request to the authentication system at step 2401. The authentication system 140 various data points may be collected such as operating system, browser version, installed fonts and plugins, screen resolution, time zone, battery level, geographic location, MAC address, passkey, biometric, digital certificates and internet protocol (IP) address at step 2402. The data may include email address and access data related to HTTP, SPF, DKIM and DNS results. A check for reliability is performed of the data collected from customer device 1 150 (step 2403). This may include identifying the user and accessing a library (library 169 Customer account information 124) of past data collection and flagging variations or irregularities. If the check provides a response of NO (step 2404) , the customer device 1 150 may be alerted and the transaction paused or canceled (step 2405). If the check provides a response of YES (step 2306), the authentication system 140 may generate a token or other unique identifier associated with the data collected from customer device 1 150 step 2407. The authentication system 140 may share the token with multiple devices (Step 2408). Customer device 2 180 may access the token and generate a request (step 2409). The Customer device 2 180 request is submitted to the authentication system 140 with the token and the authentication system 140 collects the customer device 2 data (step 2410). The data may include email address and access data related to HTTP, SPF, DKIM and DNS results. A check for reliability is performed of the data collected from Customer device 2 180 (step 2411). This may include identifying the user and accessing a library (library 169 Customer account information 124) of past data collection and flagging variations or irregularities. If the check provides a response of NO (step 2412), the customer may be alerted and the transaction paused or canceled (step 2413). If the check provides a response of YES (step 2414), the authentication system 140 may determine if multidevice analysis is required (step 2415). If the check provides a response of NO (step 2416), the transaction is allowed to proceed (step 2417). If the check determines multidevice analysis is required, designated by YES (step 2418), the authentication system 140 may submit the customer device 2 180 and customer device 1 150 to joint analysis (step 2419). As described above, a specific algorithm may be applied to the multiple of devices and the required actions and expected behaviors, required for the category of transaction requested, If the check provides a response of NO (step 2420), the customer may be alerted and the transaction paused or canceled (step 242i). If the check provides a response of YES (step 2422), the authentication system allows the transaction to proceed (Step 2423) This process may be integrated into the security process described in FIGS. 22A, 22B, 23, 25 and 26. SMS messages or social media posts may be substituted for email messaging. SMS social media Unit 158 may substitute for Email client 156 and SMS social media Unit 188 may substitute for email client 186. Secure transactions may be blockchain secured by security module 162.

FIG. 25 is a diagram illustrating the flow 2500 of transactions between the authentication system 140, the vendor 120 and the customer device 1 150 for granting a secure login using email without a password utilizing biometric credentials.

The biometrics described in the patent specification can be implemented through a combination of hardware and software components to ensure accurate identification and authentication. At the core of the implementation is a biometric sensor that captures unique physiological or behavioral traits such as fingerprints, iris patterns, facial features, or voiceprints. The captured biometric data is processed and converted into a digital representation through feature extraction algorithms. For instance, in the case of fingerprint recognition, the sensor captures the ridges and valleys of the finger, and an algorithm extracts key features such as minutiae points for further processing.

Once the biometric data is extracted, it is securely stored in a database or a decentralized ledger, such as a blockchain, in an encrypted format. The storage mechanism ensures that the data is protected against unauthorized access or tampering. When a user attempts authentication, the system captures new biometric data and compares it against the stored template using pattern-matching algorithms. If the captured data matches the stored template within a predefined threshold, the system authenticates the user and grants access.

To enhance security and privacy, the implementation may incorporate techniques like secure multiparty computation or homomorphic encryption, enabling the system to verify biometrics without exposing the actual data. Additionally, advanced machine learning models can be integrated to improve the accuracy and robustness of the biometric system, especially in challenging scenarios involving partial data, varying lighting conditions, or other environmental factors. These models can adapt to changes in user traits over time, ensuring consistent performance.

Furthermore, the system can be deployed across various platforms, including mobile devices, access control systems, and cloud-based applications, making it highly versatile. By leveraging secure hardware modules, such as Trusted Platform Modules (TPMs) or Secure Enclaves, the biometric data can be processed and stored locally, reducing reliance on external servers and mitigating potential breaches. This robust and adaptive framework ensures that the biometrics described in the patent specification can be implemented effectively across a wide range of use cases while maintaining high levels of security and user trust. The authentication system 140 may generate mailto links and tokens for the purpose of granting secure transactions without a password. URLs that generate email messages may substituted for mailto links. The token may contain transaction detail, security keys or secret pins. The authentication of an email message serves as sufficient proof of customer identity.

As shown in FIG. 25, the customer device 1 150 accesses browser unit 155 (step 2501) and submits a request for a secure transaction to the authentication system (step 2502). The authentication system establishes a subscription, generates a token and mailto link and determines that a biometric credential is required (step 2503). The authentication system 140 shares (2504) the mailto link and token with the customer device 1 120. The mailto link and token is accessed by the browser unit of the customer device 150 and triggers the biometric unit 190 (2505) of the customer device 1 150 to request the input of a biometric (2506). This biometric may be part of the operating system of the customer device 1 150 or an application or integrated as part of the browser application or email client. This may include facial or voice recognition, fingerprint or retinal scan or retinal imaging. The biometric is input by the customer (2507) and if not confirmed the transaction may be paused or canceled. If the biometric credentials is confirmed the transaction proceeds. The mailto link is triggered at device browser unit 155 (2508) of the customer device 1 150. The email client of the customer device 150 then generates (2509) and sends (2510) an email message addressed to the authentication system 140. The email message may contain the token. The token and subscription and biometric confirmation may be anywhere in the email message. The token may be integrated into the email address. Alternatively, the email address of the customer may serve as the identifier. The customer may select ‘Send’ to transmit the message to the authentication system 140. Alternatively the message may be sent automatically. The authentication system 140 performs a series of checks and authentication (2511).

The core unit 149 at the authentication system 140 performs a series of checks and authentication. The authentication system 140 authenticates the email using the digital signature. These include but are not limited to the following. 1) Verification of digital signature, Uses DKIM (DomainKey Identified Mail) protocol 2) Verification of secure path, Uses SPF (Sender Policy Framework) protocol which tracks the path of every email message, from server to server, to ensure authenticity. The authentication system 140 may perform a check based on DMARC. 3) Decoding of tokens 4) Monitoring the collected data of the customer device. To ensure the security of the user device the authentication system 140 utilizes an algorithm to monitor changes to the collected data described in FIG. 24. 5) Artificial Intelligence checks may be employed as described in FIG. 23.

Biometric credentials is confirmed. The authentication system may determine additional biometric is required. Based on the checks and authentication results, the authentication system 140 may take various actions in response. If the message is determined to be not secure additional confirmations may be sent to the customer and alerts sent to the vendor and/or domains. The authentication system 140 may validate and authenticate the message. If the message is determined to be secure and authenticated, the token is decoded and may contain the subscription. Authentication may be limited to DKIM, DMARC or SPF path-base authentication. Only one form of authentication may be required. The authentication system 140 authenticates the digital signature in the customer email.

The authentication system 140 may decode the token and perform a lookup with the subscription details. If the message is determined to be secure and authenticated, the transaction proceeds and the authentication system 140 looks up the subscription. The authentication system 140 may determine that all requirements are met and may perform the secure transaction at this point, for example to process the payment. Alternatively or additionally the authentication system 140 may publish a “pledge”, as a customer's intention to make a payment. The published pledge maybe be a publicly visible advertisement. (Not depicted)

The core unit 149 of the authentication system 140 utilizes a WebSocket connection and broadcast (2512) the subscription details to the browser unit of the customer device and triggers the biometric unit (2513) of the customer device 1 150 to request the input of a biometric. The customer inputs their biometric (2514). This biometric may be part of the operating system of the customer device or an application or integrated as part of the browser application or email client. This may include facial or voice recognition, fingerprint or retinal scan or retinal imaging. The biometric is input by the customer and if not confirmed the transaction may be paused or canceled. If the biometric is confirmed the transaction proceeds and the authentication system 140 grants secure access to the customer device 1 150 (step 2515). The customer may be presented with a series of selections or options on the browser screen. The customer, having accessed a secure channel, makes a selection at the browser unit 155. This may be achieved by a WebSocket connection. These selections may be a choice of many possible options for example credit card selection, an amount change or deliver instructions, these serve as an example only. The customer device 1 150 may exchange a series of requests (2516) with the authentication system 140. The secure channel's series of requests may be the biometric confirmation. The series of exchanges may also update the series of items to be purchased in a checkout. These exchanges may utilize the process described in FIG. 22A utilizing AI/Machine Learning 182 at step 2207. In this sample there is only one request shared with the API unit of the authentication system 140 but multiple exchanges are possible.

The API unit of authentication system 140 processes the secure transaction (2517) a notification to the customer device (2518). Although in this example payment processing is an example only. Various secure transactions may be granted. A secure transaction may be access to a secure server, secure website, payment processing, control of a digital currency, record keeping, securities and/or contracts. Alternatively, a secure transaction may be granted to either the vendor, third-party or the customer. SMS messages or social media posts may be substituted for email messaging. SMS social media Unit 158 may substitute for Email client 156 and SMS social media Unit 188 may substitute for email client 186. Secure transactions may be blockchain secured by security module 162.

FIG. 26 is a flow diagram 2600 illustrating flow of transactions within the authentication system 140, for granting a secure transactions using authentication via FIDO 2 standard and email without a password. Disclosed is a process where the authentication system authenticates, validates, decodes tokens, collects device data to confirm customer identity. This process may be integrated into the security process described in FIGS. 22A, 22B, 23, 24 and 25, utilizing digital credentials which may comply with the FIDO 2 standard or use other equivalent methods in compliance with the FIDO Alliance and the World Wide Web Consortium.

Flow 2600 the customer device may submit a request to the authentication system 140 at step 2601. The authentication system 140 identifies the type of transaction requested by a customer device 1 150 (step 2602). The authentication system 140 may parse various requests based on different requirements. The authentication system 140 identifies if the transaction request requires an authentication via FIDO 2 standard credential confirmation (step 2603). If the check provides a response of NO (step 2604), the transaction process may be allowed to proceed without an authentication via FIDO 2 standard confirmation. (step 2605). If the check provides a response of YES (step 2606), the authentication system 140 may run a check if that customer device FIDO 2 standard credential confirmation was confirmed (step 2607). If the check provides a response of NO (step 2608), the transaction process paused or canceled and the customer alerted (step 2609). If the check provides a response of YES (step 2610), the authentication system 140 may allow the transaction to proceed (2611). The process described above may be integrated into an authentication via FIDO 2 standard application or maybe integrated into the authentication system or vendor. The authentication via FIDO 2 standard credential confirmation may not be directly associated with the transaction but one of several data points collected as described above in FIG. 23, FIG. 24 and FIG. 25. SMS messages or social media posts may be substituted for email messaging. SMS social media Unit 158 may substitute for email client 156 and SMS social media Unit 188 may substitute for email client 186. Secure transactions may be blockchain secured by security module 162.

The process described above may utilize one or more blockchain registries to secure customer and vendor transactions. Nonvisible email clients 157 and 187 may be substituted for conventional email clients described above.

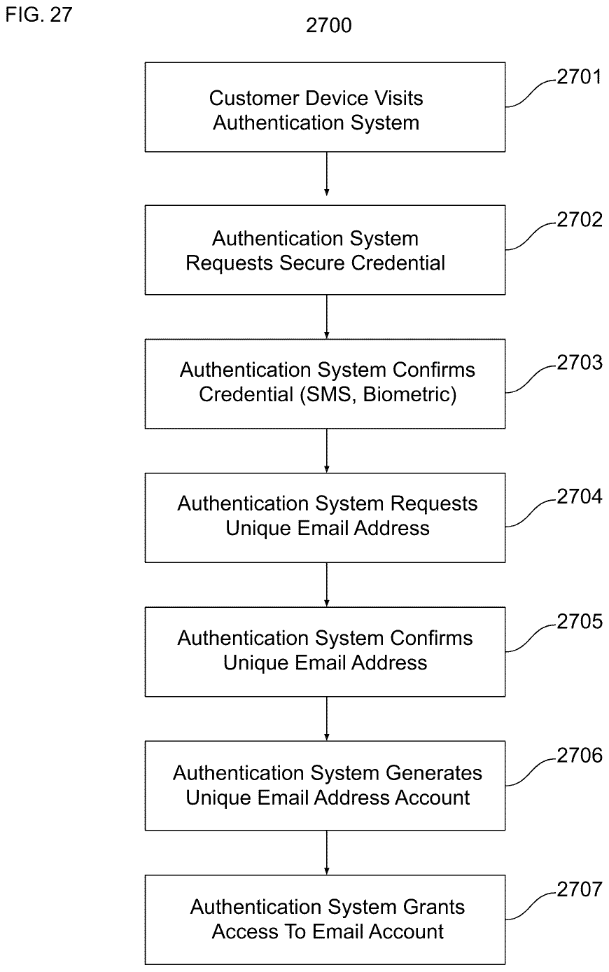

FIG. 27 is an illustration of a method 2700 depicting an authentication system 140 requesting, generating and granting access to an email account without a password. The authentication system 140 requests credentials from a customer device that are specific to the device, the physical attributes of the customer's body and or state issued credentials. These may be dependent on multiple customer devices. These credentials may be established by HTTP or SMS transmissions. The authentication system 140 may generate an email account for a customer and grant access to that email account based on the authenticated credentials.

Method 2700 begins with customer device 1 150 visiting and accessing authentication system 140 (2701). This may be accessed via a web browser or other application. Data may be collected from the customer device 1 150 by the authentication system 140. The authentication system 140 may require the customer to input information such as a phone number, account number, license, social security or tax identification. The authentication system 140 requests a secure credential (2702). For example, the request may be that the customer enters a telephone number associated with the customer device 1 150. Alternatively or additionally this request may be to a third party for verification of details such as bank or state issued credentials. The authentication system 140 confirms the credential of the customer device 1 150 (2703). This may be by receiving a confirmation of biometric authentication or a token or pin via a SMS message. This may be dependent on multiple customer devices such as customer device 150 and customer device 180. Alternatively or additional This may be to a third party for verification of details such as state issues identifiers or third party confirmation. The authentication system 140 requests a unique email address from the customer device 150 (2704). The customer is required to choose an email address which is available and unique. The authentication system 140 confirms a unique email address for the customer device 1 150 (2705) and generates the email account associated with the customer (2706). The email account may be generated by a third party provider such as Unit 170. Based on the authentication of credentials and the unique address the authentication system 140 grants access to the customer email account (2707). Access to the secure email account may be granted to more than one device for example customer device 2 180. Secure transactions may be blockchain secured by security module 162. The process described above may utilize one or more blockchain registries to secure customer transactions. Nonvisible email clients 157 and 187 may be substituted for conventional email clients described above.

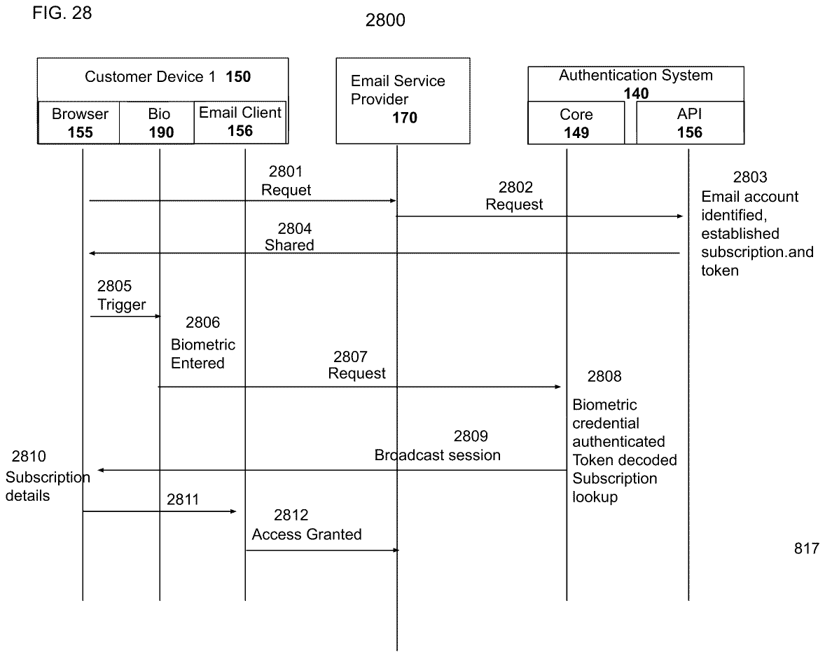

FIG. 28 is a diagram illustrating the flow 2800 of transactions between the authentication system 140, the email service provider 170 and the customer device 1 150 for granting a secure login to an email account without a password utilizing biometric confirmation. The authentication system 140 may receive and confirm biometric credential authentication for the purpose of granting secure transactions without a password. The token may contain transaction detail, security keys or secret pins. The email service provider 170 may control the email client 156 and utilize the authentication system 140 for authenticating customer login. The confirmation and authentication of biometric digital credentials may serve as sufficient proof of customer identity.

The customer device 1 150 accesses browser unit 155 and submits a request for a secure transaction to facilitate login to the email service provider 170 (2801). The email service provider 170 may redirect this request to the authentication system 140 API 146 (2802). The authentication system 140 confirms the customer account and associated email address, establishes a subscription, request for biometric credential and generates a token (2803). The API 146 of the authentication system 140 shares (2804) the request for biometric credential and token with the browser 155 of the customer device 1 150. The browser unit 155 of the customer device 150 and triggers the biometric unit 190 (2505) of the customer device 1 150 to request the input of a biometric. This biometric may be part of the operating system of the customer device 1 150 or an application or integrated as part of the browser application or email client. This may include but not limited to facial or voice recognition, fingerprint or retinal scan or retinal imaging. The biometric is input by the customer (2806) and if not confirmed the transaction may be paused or canceled. If the biometric is confirmed the transaction proceeds and the biometric credentials and token are shared with the core 149 of authentication system 140 (2807). The authentication system 140 performs a series of checks and authentication (2808). 1) Authenticating the biometric credential 3) Decoding of tokens 4) Monitoring the collected data of the customer device. To ensure the security of the user device the authentication system 140 utilizes an algorithm to monitor changes to the collected data described in FIG. 23. 5) Artificial Intelligence checks may be employed as described in FIG. 24.

Based on the checks and authentication results, the authentication system 140 may take various actions in response. If the message is determined to be not secure additional confirmations may be sent to the customer and alerts sent to the email service provider 170 and/or domains. The authentication system 140 may validate and authenticate the credentials. If the message is determined to be secure and authenticated, the token is decoded and may contain the subscription. Only one form of authentication may be required. The authentication system 140 may decode the token and perform a lookup with the subscription details. If the message is determined to be secure and authenticated, the transaction proceeds and the authentication system 140 looks up the subscription.

The core unit 149 of the authentication system 140 utilizes a WebSocket connection and broadcast (2809) the subscription details to the browser unit 155 of the customer device 150 (2810) and shares the details to the email client 156 of the customer device 1 150 (2811) and access granted to email service provider 170 (2812). Alternatively or additionally, the session associated with the subscription may be shared with the biometric unit 190 to facilitate access to the email client. The customer may then have access to the email client 156 and send and receive messages in a secure fashion. The email client may be accessed by a secure web browser or a desktop application. Secure transactions may be blockchain secured by security module 162. The process described above may utilize one or more blockchain registries to secure customer transactions. Nonvisible email clients 157 and 187 may be substituted for conventional email clients described above.

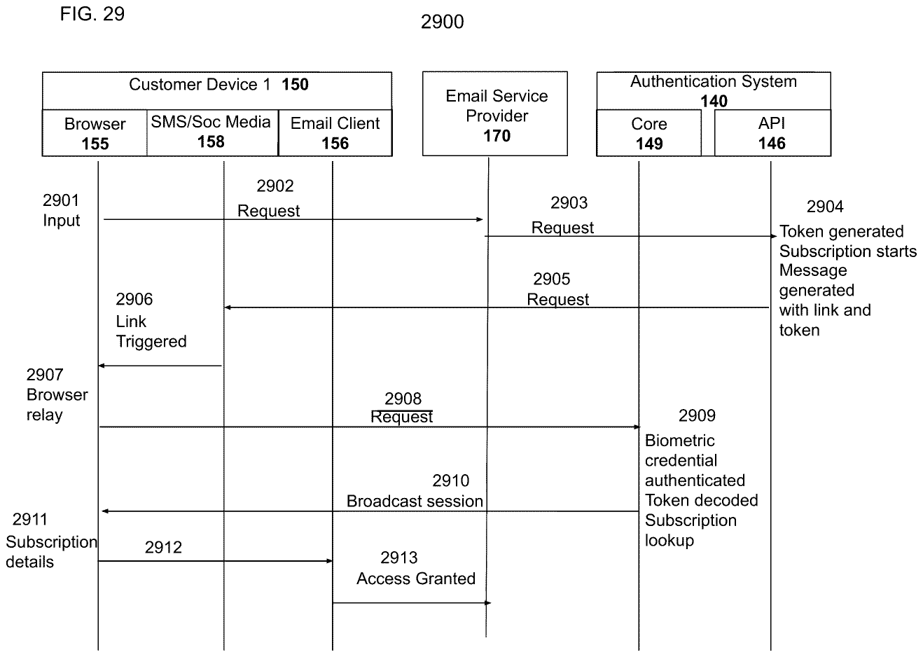

FIG. 29 is a diagram illustrating the flow 2900 of transactions between the authentication system 140, the email service provider 170 and the customer device 1 150 for granting a secure login to an email account without a password utilizing SMS messaging. The authentication system 140 may receive and confirm SMS authentication for the purpose of granting secure transactions without a password. The token may contain any of the fields discussed above. The email service provider 170 may control the email client 156 and utilize the authentication system 140 for authenticating customer login. The confirmation and authentication of the SMS, tokens and digital credentials may serve as sufficient proof of customer identity.

The customer device 1 150 accesses browser unit 155 and inputs the required prompt to request login to the email client 156 (2901). This may be the telephone number of the customer. Alternatively this may be input via SMS/Soc Media 158. This prompt may be submitted to the email client 156 and the application may transmit the request for access by HTTP. The customer device 1 150 submits a request for a secure transaction to facilitate login to the email service provider 170 (2902). The email service provider 170 may redirect this request to the authentication system 140 API 146 (step 2803). The authentication system 140 confirms the customer account and associated email address, establishes a subscription, request for SMS credential link and generates a token (step 2904). The authentication system 140 may look up and confirm that the telephone number provided is an active account and generate and SMS message containing SMS credential link and token. The API 146 of the authentication system 140 share (2905) the message link with the SMS/Soc Media 158. of the customer device 1 120. The SMS/Soc Media 158 triggers the link (2906) and engages the browser 155 and shares the token with the core 149 of authentication system 140 (2908). The link be automatically triggered and may not require the input of the customer. Alternatively the customer may be required to input a pin associated with the token and subscription. The authentication system 140 performs a series of checks and authentication (2909) 1) Authenticating and validating the token and or pin 3) Decoding of tokens 4) Monitoring the collected data of the customer device. To ensure the security of the user device the authentication system 140 utilizes an algorithm to monitor changes to the collected data described in FIG. 24. 5) Artificial Intelligence checks may be employed as described in FIG. 23. 6) Biometric confirmation as described in FIG. 25 and FIG. 28. 7) FIDO 2 requirement as described in FIG. 26.

Based on the checks and authentication results, the authentication system 140 may take various actions in response. If the message is determined to be not secure additional confirmations may be sent to the customer and alerts sent to the email service provider 170 and/or domains. The authentication system 140 may validate and authenticate the token. If the message is determined to be secure and authenticated, the token is decoded and may contain the subscription. Only one form of authentication may be required.

The authentication system 140 may decode the token and perform a lookup with the subscription details. If the message is determined to be secure and authenticated, the transaction proceeds and the authentication system 140 looks up the subscription.

The core unit 149 of the authentication system 140 utilizes a WebSocket connection and broadcast (2810) the subscription details to the browser unit of the customer device (2911) and shares the details to the email client 156 of the customer device 1 150 (2912) and access granted to email service provider 170 (2913). The customer may then have access to the email client 156 and send and receive messages in a secure fashion. The email client may be accessed by a secure web browser or a desktop application. Secure transactions may be blockchain secured by security module 162. The process described above may utilize one or more blockchain registries to secure customer transactions. Nonvisible email clients 157 and 187 may be substituted for conventional email clients described above.

It should be understood that many variations are possible based on the disclosure herein. Although features and elements are described above in particular combinations, each feature or element may be used alone without the other features and elements or in various combinations with or without other features and elements.

The methods or flow charts provided herein may be implemented in a computer program, software, or firmware incorporated in a non-transitory computer-readable storage medium for execution by a general-purpose computer or a processor. Examples of non-transitory computer-readable storage mediums include a read-only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

The method described herein may be implemented by a single processor executing instructions stored on a non-transitory computer-readable medium or by multiple processors operating collectively to perform the disclosed functions. In implementations involving multiple processors, the processing tasks may be distributed among different computing devices, processors, or processing cores, which may operate in parallel or in a coordinated manner to achieve the described functionality. The processors may be configured to communicate via a wired or wireless network, shared memory, or other suitable communication mechanisms. Accordingly, references to a “processor” herein are intended to encompass both singular and distributed implementations unless explicitly stated otherwise.

A unit as described herein may be implemented as a hardware component, a software module executed by a processor, or a combination of both. In some embodiments, a unit may comprise a dedicated hardware circuit, such as an application-specific integrated circuit (ASIC), a field-programmable gate array (FPGA), or a combination of processors, memory, and interfaces configured to execute specific functions. Alternatively, a unit may be implemented as software instructions stored in a non-transitory computer-readable medium and executed by one or more processors to perform the described functions. The unit may also be distributed across multiple devices or systems, communicating over a network to collectively execute its designated operations. Accordingly, the implementation of a unit may vary based on system architecture, computational requirements, and integration with other components, without departing from the scope of the present invention.

What is claimed is:

1. A method for authenticating a user for secure transactions without requiring a password, comprising:
receiving, at an authentication system, a request from a vendor system to authenticate the user for a transaction;
generating an authentication request message that includes an authentication token associated with the user;
transmitting the authentication request message to an email address associated with the user;
receiving, at the authentication system, a response email from a device of the user, the response email containing the authentication token;
validating whether the response email originates from an authenticated source by analyzing email metadata, digital fingerprinting, or biometric confirmation data;
determining, based on the validation, whether to grant or deny authentication for the transaction; and
transmitting an authentication confirmation message to the vendor system if authentication is granted.

2. A system for providing passwordless authentication for secure transactions, comprising:
an authentication server configured to generate authentication request messages containing authentication tokens;
a communication process that transmits authentication request messages to a user's email account;
a validation process that analyzes incoming response emails, verifies authentication tokens, and confirms email authenticity using domainkeys identified mail (DKIM), sender policy framework (SPF), and artificial intelligence-based anomaly detection;
a transaction execution process that coordinates with vendor systems to process authentication requests and approve transactions; and
a biometric verification process that enhances security by integrating user biometric data, digital fingerprinting, and behavioral analysis for authentication validation.

3. A non-transitory computer-readable medium storing instructions that, when executed by one or more processors, cause a computing device to perform a method for passwordless authentication, the method comprising:
receiving a request from a vendor system to authenticate a user for a transaction;
generating an authentication request that includes an authentication token and transmitting the request to an email address associated with the user;
receiving a response email from a device of the user that includes the authentication token;
verifying whether the response email originates from an authenticated source by analyzing metadata, digital fingerprints, or biometric confirmation data;
determining whether to approve or deny authentication based on the verification results; and
providing an authentication response to the vendor system, granting or denying access based on the verification.

4. The method of claim 1, further comprising encrypting the authentication token using a public-private key pair before transmitting it to an email account of the user.

5. The system of claim 2, wherein the authentication server is further configured to integrate with third-party email service providers and payment processing systems to facilitate secure transactions.

6. The method of claim 1, wherein the authentication system applies fraud detection techniques that utilize machine learning to analyze authentication patterns and detect anomalies indicative of unauthorized access attempts.

7. The system of claim 2, wherein biometric verification includes facial recognition, fingerprint scanning, or voice authentication to confirm user identity.

8. The method of claim 3, wherein the authentication token expires after a predefined time period to enhance security against replay attacks.

9. The system of claim 2, further comprising a blockchain-based record-keeping process that logs authentication transactions in a decentralized ledger for increased transparency and security.

10. The method of claim 3, wherein the instructions further enable natural language processing to interpret user instructions included in authentication emails and automate certain account actions.

11. The method of claim 1, further comprising detecting a risk level associated with the authentication attempt based on a geographic location or digital fingerprint.

12. The system of claim 2, wherein the authentication request is transmitted using a secure email protocol that supports end-to-end encryption.

13. The method of claim 3, wherein the computing device applies a reputation score to the authentication request based on historical behavior of the user.

14. The system of claim 2, wherein email-based authentication is supplemented with an out-of-band verification step, including SMS verification or push notifications to a mobile device.

15. The method of claim 1, wherein the authentication request includes a dynamic QR code that must be scanned by a secondary device to complete the authentication process.

16. The system of claim 2, wherein artificial intelligence-based behavioral analysis is used to detect unauthorized account access by comparing current login behavior with historical user activity.

17. The method of claim 3, wherein the computing device automatically denies authentication requests from high-risk IP addresses associated with prior fraudulent activity.

18. The system of claim 2, wherein authentication tokens are time-restricted and require periodic renewal through email verification to maintain active user sessions.

19. The method of claim 1, further comprising dynamically adjusting authentication security measures based on real-time threat intelligence feeds.

20. The system of claim 2, wherein multi-device authentication is utilized by requiring user confirmation from at least two trusted devices before approving a sensitive transaction.
